(19) United States
(12) Patent Application Publication
(10) Pub. No.: US 2020/0183574 A1
(43) Pub. Date: Jun. 11, 2020

(54) Multi-Task Operation Method and Electronic Device

(71) Applicant: Huawei Technologies Co., Ltd., Shenzhen (CN)

(72) Inventors: Xiaoxiao Chen, Nanjing (CN); Weiching Chung, Shenzhen (CN); Bing Li, Shenzhen (CN); Yuxi Zhang, Shanghai (CN); Bifeng Tong, Nanjing (CN)

(21) Appl. No.: 16/631,735

(22) PCT Filed: Jul. 18, 2017
(86) PCT No.: PCT/CN2017/093430

§ 371 Date: Jan. 16, 2020

(51) Int. Cl. G06F 3/0488; G06F 3/0486; G06F 3/0482

(52) U.S. Cl. CPC G06F 3/04883; G06F 3/0486; G06F 2203/04803; G06F 2203/04808; G06F 3/0482

(57) ABSTRACT

A multi-task operation method includes displaying, an interface of a first application program in a maximized way; receiving a sliding operation of pushing up from a lower edge of the screen with more than two fingers by a user on the interface of a first application program; displaying two areas on split screens in response to the sliding operation; displaying a division line between the two areas for control of the two areas; displaying an icon of a second application program in the second area; receiving, by the electronic device, a second operation triggered by a user on the icon of a second application program; and displaying an interface of the second application program in the second area in response to the second operation.

### TECHNICAL FIELD

This application relates to the field of electronic device technologies, and in particular, to a multi-task operation method and an electronic device.

### BACKGROUND

Currently, a display screen of an electronic device such as a mobile phone or a personal digital assistant (personal digital assistant, PDA) becomes larger. To fully use display features of large screens, more electronic devices support a screen splitting function.

In the prior art, using a mobile phone as an example, a method for enabling a screen splitting function includes the following steps: Referring to FIG. 1-1 and FIG. 1-2, icons of a plurality of application programs are displayed on a home screen 101 of the mobile phone. As shown by an operation 1011, a user starts a first application program by performing a tapping operation or the like, to display an interface 102 of the first application program. Then as shown by a process 1021, the user slides from an edge of the interface 102 of the first application program to display a menu 103, where the sliding includes single-finger sliding and further includes multi-finger sliding such as two-finger or three-finger sliding. The menu 103 displays an icon of one or more other second application programs that support the screen splitting function. The user may select, from the menu 103, a second application program for screen splitting with the currently displayed first application program. When the user selects an icon of a second application program, the mobile phone loads an interface 104. The interface 104 includes a first display area 1041 and a second display area 1042, where the interface of the first application program is displayed in the first display area 1041, and an interface of the second application program is displayed in the second display area 1042. For example, in FIG. 1-1 and FIG. 1-2, the first application program is a video application, and the second application program selected by the user is a WeChat application.

### SUMMARY

Embodiments of this application provide a multi-task operation method and an electronic device to resolve a problem in the prior art that an operation is inconvenient because it is necessary to slide from an edge of an interface of an application to enable a screen splitting function after the application is started.

To achieve the foregoing objective, the following technical solutions are used in the embodiments of this application:

According to a first aspect, a multi-task operation method is provided, and is applied to a scenario in which an electronic device displays a home screen (an interface displaying icons of a plurality of application programs). In this scenario, the method includes the following steps: displaying, by an electronic device, icons of a first quantity of application programs; then receiving a preset operation triggered by a user on icons of a second quantity of application programs among the icons of the first quantity of application programs; and displaying, by the electronic device, interfaces of the second quantity of application programs on split screens in response to the preset operation, where
the second quantity is greater than or equal to two and less than or equal to the first quantity; and the preset operation includes any one of the following operations: an operation of tapping the icons of the second quantity of application programs, an operation of multi-tapping the icons of the second quantity of application programs, an operation of pressing the icons of the second quantity of application programs, a first sliding operation of continuously sliding along a first direction after pressing the icons of the second quantity of application programs, and a second sliding operation of continuously sliding along a second direction to the icons of the second quantity of application programs after pressing any point other than the icons of the second quantity of application programs.

In the foregoing method, the user can directly perform a shortcut operation on icons of two or more applications on a home screen to display the two or more applications on split screens. Therefore, a split-screen displaying method that is faster and more convenient is provided.

In a possible design of the first aspect, the second quantity of application programs includes a first application program and a second application program, the first application program is a first type of preset application program or a first preset application program, and the second application program is a second type of preset application program or a second preset application program; and when the electronic device displays an interface of the first application program and an interface of the second application program on split screens, a display proportion of the interface of the first application program on a display screen of the electronic device is greater than a display proportion of the interface of the second application program on the display screen of the electronic device.

In a possible design of the first aspect, the second quantity of application programs includes a first application program and a second application program; and the electronic device stores a historical screen splitting record about displaying the first application program and the second application program on split screens, where the historical screen splitting record includes relative positions of the first application program and the second application program and display proportions of the first application program and the second application program on a display screen of the electronic device; and when the electronic device displays an interface of the first application program and an interface of the second application program on split screens, the electronic device displays the interface of the first application program and the interface of the second application program on split screens based on the historical screen splitting record.

According to a second aspect, a multi-task operation method is provided, and is applied to a scenario in which an electronic device displays a home screen. In this scenario, the method includes: displaying, by an electronic device, icons of a first quantity of application programs; then receiving a first operation performed by a user on an icon of a first application program; and displaying, by the electronic device, a first interface and a second interface on split screens in response to the first operation, where
the first interface is an interface of the first application program, the second interface is used to display icons of a second quantity of application programs, and the second quantity is less than the first quantity; and
the first operation includes any one of the following operations: an operation of tapping the icon of the first application program by using a plurality of fingers, an operation of double-tapping the icon of the first application program, an operation of pressing the icon of the first application program, a first sliding operation of continuously sliding along a first direction after pressing the icon of the first application program, and a second sliding operation of continuously sliding along a second direction to the icon of the first application program after pressing any point other than the icon of the first application program.

In the foregoing method, the user does not need to open the interface of the first application program, but can directly trigger a shortcut operation such as the first operation on the icon of the first application program; when the electronic device detects the shortcut operation, the electronic device may display the interface of the first application program and icons of other application programs on split screens; and further, the user selects, from the application programs, a target application program to be displayed with the first application program on split screens. Therefore, a split-screen displaying method that is faster and more convenient can be provided.

In a possible design of the second aspect, a display proportion of the first interface on a display screen of the electronic device is greater than a display proportion of the second interface on the display screen of the electronic device.

In a possible design of the second aspect, the electronic device stores a historical screen splitting record corresponding to the first application program, where the historical screen splitting record is used to record at least one second application program displayed with the first application program on split screens in a historical screen splitting operation of the user; and the second quantity of application programs includes the at least one second application program recorded in the historical screen splitting record.

In a possible design of the second aspect, after the displaying, by the electronic device, a first interface and a second interface on split screens, the method further includes: receiving, by the electronic device, a second operation performed by the user on a target second application program on the second interface; and displaying, by the electronic device, the interface of the first application program and an interface of the target second application program on split screens in response to the second operation, where
the second operation is used to trigger the electronic device to start the target second application program.

According to a third aspect, a multi-task operation method is provided, and the method includes: displaying, by an electronic device, a first interface, where the first interface is an interface of a first application program; receiving, by the electronic device, a preset operation performed by a user on the first interface; and displaying, by the electronic device, the first interface and a second interface on split screens in response to the preset operation, where the second interface is used to display an icon of at least one second application program, where
the preset operation includes a sliding operation triggered when a touch area between the user and the first interface is greater than a first threshold.

In the foregoing method, in a scenario in which the electronic device starts the first application program, the user may perform a sliding operation by using a palm on the interface of the first application program to trigger the electronic device display the interface of the first application program and the icon of the at least one second application program on split screens. Therefore, a screen splitting manner of triggering screen splitting by detecting a touch area between the user and the interface of the first application program is provided.

In a possible design of the third aspect, a display proportion of the first interface is greater than a display proportion of the second interface.

According to a fourth aspect, a multi-task operation method is provided, and the method includes: displaying, by an electronic device, a first interface, where the first interface is an interface of a first application program; receiving, by the electronic device, a voice instruction input by a user; and displaying, by the electronic device, the first interface and a second interface on split screens in response to the voice instruction, where
the second interface may be an interface of a second application program, or may be an interface displaying icons of a plurality of second application programs.

In the foregoing method, in a scenario in which the first application program is started on the electronic device, the user may input a voice to instruct the electronic device to display the interface of the first application program and the second interface on split screens. Therefore, a split-screen displaying method that is faster and more convenient is provided.

In a possible design of the fourth aspect, the voice instruction is used to indicate a second application program to be displayed with the first application program on split screens; and the displaying, by the electronic device, the first interface and a second interface on split screens in response to the voice instruction includes: displaying, by the electronic device, the interface of the first application program and an interface of the second application program on split screens in response to the voice instruction.

In a possible design of the fourth aspect, the voice instruction is used to instruct the electronic device to enable a screen splitting function; and the displaying, by the electronic device, the first interface and a second interface on split screens in response to the voice instruction includes: displaying, by the electronic device, the interface of the first application program and the second interface on split screens in response to the voice instruction, where the second interface displays an icon of at least one second application program.

In a possible design of the fourth aspect, after the displaying, by the electronic device, the interface of the first application program and the second interface on split screens, the method further includes: receiving, by the electronic device, a second operation performed by the user on an icon of a target second application program in the at least one second application program, where the second operation is used to trigger starting of the target second application program; and displaying, by the electronic device, the interface of the first application program and an interface of the target second application program on split screens in response to the second operation.

According to a fifth aspect, a multi-task operation method is provided, and includes: displaying, by an electronic device, a first interface, where the first interface displays an icon of at least one application program; receiving, by the electronic device, a preset operation performed by a user on an icon of a first application program in the at least one application program; and displaying, by the electronic device, an interface of the first application program on the first interface in an overlapping manner in response to the preset operation, where the preset operation includes an operation of continuously sliding along a first direction after pressing the icon of the first application program.

In the foregoing method, in a scenario in which the electronic device displays a home screen (displaying icons of a plurality of application programs), when detecting the operation performed by the user on the icon of the first application program on the home screen, the electronic device displays the interface of the first application program on the home screen in a picture-in-picture manner in response to the operation. Therefore, a convenient and fast method for displaying an application program is provided.

In a possible design of the fifth aspect, the preset operation includes an operation of continuously sliding along a first direction to a first position of the first interface after pressing the icon of the first application program; and the displaying, by the electronic device, an interface of the first application program on the first interface in an overlapping manner in response to the preset operation includes: displaying, by the electronic device, the interface of the first application program in the first position of the first interface in the overlapping manner in response to the preset operation.

In a possible design of the fifth aspect, the electronic device stores a historical display record about displaying the interface of the first application program on the first interface in the overlapping manner, where the historical display record includes a display size and a display position of the interface of the first application program; and the displaying, by the electronic device, an interface of the first application program on the first interface in an overlapping manner in response to the preset operation includes: displaying, by the electronic device, the interface of the first application program on the first interface in the overlapping manner based on the historical display record in response to the preset operation.

According to a sixth aspect, a multi-task operation method is provided, and the method includes: displaying, by an electronic device, an interface of a first application program and a recent task list, where the recent task list includes an icon of at least one second application program; then receiving, by the electronic device, a preset operation performed by a user on an icon of a target second application program in the recent task list; and displaying, by the electronic device, an interface of the target second application program in response to the preset operation, and adding the first application program to the recent task list, where
the preset operation is used to trigger starting of the target second application program, and specifically, the preset operation includes any one of the following operations: an operation of tapping or multi-tapping the icon of the target second application program, an operation of pressing the icon of the target second application program, and an operation of dragging the icon of the target second application program to the interface of the first application program after pressing the icon.

In the foregoing method, the electronic device displays the interface of the first application program and the recent task list on split screens, where the recent task list includes icons of a plurality of second application programs. Further, when the electronic device detects an operation performed by the user on an icon of a second application program in the recent task list, the electronic device displays an interface of the second application program, and displays the icon of the first application program in the recent task list.

According to a seventh aspect, a multi-task operation method is provided, and is applied to a scenario in which an electronic device is locked, for example, when a screen of the electronic device is locked or turned off. In this scenario, the electronic device receives a first shortcut operation input by a user on a locked screen interface, and displays a first application program and a second application program on split screens in response to the first shortcut operation. The electronic device receives a second shortcut operation input by the user on the locked screen interface, and the electronic device displays a third application program and a fourth application program on split screens in response to the second shortcut operation. The electronic device receives a third shortcut operation input by the user on the locked screen interface, and the electronic device displays an interface of the first application program on a home screen (an interface displaying an icon of an application program installed on the electronic device) in an overlapping picture-in-picture manner in response to the third shortcut operation.

The shortcut operation may be a fingerprint or a gesture input by the user, pressing a physical key, or the like. The first shortcut operation, the second shortcut operation, and the third shortcut operation are different shortcut operations. The first application program, the second application program, the third application program, and the fourth application program are used to represent different application programs.

According to an eighth aspect, based on various multi-task operation methods in the first aspect to the seventh aspect, when a plurality of application programs are displayed on split screens, display proportions of the application programs may be default settings. For example, the display proportions are all the same. Alternatively, display proportions of different application programs may vary according to attributes of the application programs. Using a first application program and a second application program displayed on split screens as an example, when the first application program is a first type of application program, and the second application program is a second type of application program, a display proportion of an interface of the first application program on a display screen of an electronic device is greater than a display proportion of an interface of the target second application program on the display screen of the electronic device. Alternatively, different applications may be displayed on split screens based on a historical screen splitting record. Using the first application program and the second application program displayed on split screens as an example, when the electronic device stores a historical screen splitting record of the first application program and the second application program, the first application program and the second application program are displayed on split screens based on the historical screen splitting record.

According to a ninth aspect, based on various multi-task operation methods in the first aspect to the seventh aspect, an embodiment of this application further provides an implementation of adjusting interfaces of a plurality of application programs displayed on split screens.

In an implementation, using an interface of a first application program and an interface of a second application program displayed on an electronic device as an example, the electronic device displays the interface of the first application program and the interface of the second application program on split screens. The electronic device receives a first sliding operation of sliding from the interface of the first application program to the interface of the second application program and a second sliding operation of sliding from the interface of the second application program to the interface of the first application program by a user. The electronic device interchanges display positions of the interface of the first application program and the interface of the second application program in response to the first sliding operation and the second sliding operation.

In another implementation, the electronic device displays the interface of the first application program and the interface of the second application program on split screens. The electronic device receives an operation of pressing a division line between the interface of the first application program and the interface of the second application program by the user. The electronic device interchanges display positions of the interface of the first application program and the interface of the second application program in response to the pressing operation.

According to a tenth aspect, based on various multi-task operation methods in the first aspect to the seventh aspect, an embodiment of this application further provides an implementation of exiting screen splitting.

In this implementation, an electronic device displays a first interface and a second interface on split screens, where the first interface is an interface of a first application program, and the second interface is an interface of a second application program; the electronic device receives a sliding operation of continuously sliding from a first position of a division line between the first interface and the second interface along the division line to a second position of the division line by a user; and displaying, by the electronic device, an interface of a target application program in response to the sliding operation.

The target application program is one of the first application program and the second application program. Specifically, the target application program is an application being operated before the user performs the sliding operation, that is, an application in which a focus is located. Alternatively, the target application program is an application whose display proportion is relatively large in the first application program and the second application program.

In the foregoing method, the electronic device displays the interface of the first application program and the interface of the second application program on split screens. When the user continuously slides from the first position of the division line between the two interfaces along the division line to the second position of the division line to simulate an operation of erasing the division line, the electronic device exits screen splitting, and displays only an interface of one of the application programs.

According to an eleventh aspect, an electronic device is provided, and includes a display screen, an input device, one or more processors, and a memory that are interconnected by using a bus, where the memory is configured to store one or more programs, and the one or more programs include an instruction; specifically, the display screen is configured to display icons of a first quantity of application programs; the input device is configured to receive a preset operation triggered by a user on icons of a second quantity of application programs among the icons of the first quantity of application programs; and the one or more processors are configured to display, by using the display screen, interfaces of the second quantity of application programs on split screens in response to the preset operation, where
the second quantity is greater than or equal to two and less than or equal to the first quantity; and
the preset operation includes any one of the following operations: an operation of tapping the icons of the second quantity of application programs, an operation of multi-tapping the icons of the second quantity of application programs, an operation of pressing the icons of the second quantity of application programs, a first sliding operation of continuously sliding along a first direction after pressing the icons of the second quantity of application programs, and a second sliding operation of continuously sliding along a second direction to the icons of the second quantity of application programs after pressing any point other than the icons of the second quantity of application programs.

In a possible design of the eleventh aspect, the second quantity of application programs includes a first application program and a second application program, the first application program is a first type of preset application program or a first preset application program, and the second application program is a second type of preset application program or a second preset application program; and the one or more processors are further configured to display, by using the display screen, an interface of the first application program and an interface of the second application program on split screens in response to the preset operation, where a display proportion of the interface of the first application program on the display screen of the electronic device is greater than a display proportion of the interface of the second application program on the display screen of the electronic device.

In a possible design of the eleventh aspect, the second quantity of application programs includes a first application program and a second application program; the memory is further configured to store a historical screen splitting record about displaying the first application program and the second application program on split screens, where the historical screen splitting record includes relative positions of the first application program and the second application program and display proportions of the first application program and the second application program on the display screen of the electronic device; and the one or more processors are further configured to display, by using the display screen, an interface of the first application program and an interface of the second application program on split screens based on the historical screen splitting record in response to the preset operation.

According to a twelfth aspect, an electronic device is provided, and includes a display screen, an input device, one or more processors, and a memory that are interconnected by using a bus, where the memory is configured to store one or more programs, and the one or more programs include an instruction; the display screen is configured to display icons of a first quantity of application programs; the input device is configured to receive a first operation performed by a user on an icon of a first application program; and the one or more processors are configured to display, by using the display screen, a first interface and a second interface on split screens in response to the first operation, where the first operation includes any one of the following operations: an operation of tapping the icon of the first application program by using a plurality of fingers, an operation of double-tapping the icon of the first application program, an operation of pressing the icon of the first application program, a first sliding operation of continuously sliding along a first direction after pressing the icon of the first application program, and a second sliding operation of continuously sliding along a second direction to the icon of the first application program after pressing any point other than the icon of the first application program; and the first interface is an interface of the first application program, the second interface is used to display icons of a second quantity of application programs, and the second quantity is less than the first quantity.

In a possible design of the twelfth aspect, a display proportion of the first interface on the display screen is greater than a display proportion of the second interface on the display screen.

In a possible design of the twelfth aspect, the memory is further configured to store a historical screen splitting record corresponding to the first application program, where the historical screen splitting record is used to record at least one second application program displayed with the first application program on split screens in a historical screen splitting operation of the user; and the second quantity of application programs includes the at least one second application program recorded in the historical screen splitting record.

In a possible design of the twelfth aspect, the input device is further configured to receive a second operation performed by the user on a target second application program on the second interface, where the second operation is used to trigger the electronic device to start the target second application program; and the one or more processors are further configured to display, by using the display screen, the interface of the first application program and an interface of the target second application program on split screens in response to the second operation.

According to a thirteenth aspect, an electronic device is provided, and includes a display screen, an input device, one or more processors, and a memory that are interconnected by using a bus, where the memory is configured to store one or more programs, and the one or more programs include an instruction; the display screen is configured to display a first interface, where the first interface is an interface of a first application program; the input device is configured to receive a preset operation performed by a user on the first interface; and the one or more processors are configured to display, by using the display screen, the first interface and a second interface on split screens in response to the preset operation, where the second interface is used to display an icon of at least one second application program, where the preset operation includes a sliding operation triggered when a touch area between the user and the first interface is greater than a first threshold.

According to a fourteenth aspect, an electronic device is provided, and includes a display screen, an input device, one or more processors, and a memory that are interconnected by using a bus, where the memory is configured to store one or more programs, and the one or more programs include an instruction; the display screen is configured to display a first interface, where the first interface is an interface of a first application program; the input device is configured to receive a voice instruction input by a user; and the one or more processors are configured to display, by using the display screen, the first interface and a second interface on split screens in response to the voice instruction.

In a possible design of the fourteenth aspect, the voice instruction is used to indicate a second application program to be displayed with the first application program on split screens; and the one or more processors are configured to display, by using the display screen, the interface of the first application program and an interface of the second application program on split screens in response to the voice instruction.

In a possible design of the fourteenth aspect, the voice instruction is used to instruct the electronic device to enable a screen splitting function; and the one or more processors are configured to display, by using the display screen, the interface of the first application program and the second interface on split screens in response to the voice instruction, where the second interface displays an icon of at least one second application program.

In a possible design of the fourteenth aspect, the input device is further configured to receive a second operation performed by the user on an icon of a target second application program in the at least one second application program, where the second operation is used to trigger starting of the target second application program; and the one or more processors are further configured to display, by using the display screen, the interface of the first application program and an interface of the target second application program on split screens in response to the second operation.

According to a fifteenth aspect, an electronic device is provided, and includes a display screen, an input device, one or more processors, and a memory that are interconnected by using a bus, where the memory is configured to store one or more programs, and the one or more programs include an instruction; the display screen is configured to display a first interface, where the first interface displays an icon of at least one application program; the input device is configured to receive a preset operation performed by a user on an icon of a first application program in the at least one application program; and the one or more processors are configured to display, by using the display screen, an interface of the first application program on the first interface in an overlapping manner in response to the preset operation, where the preset operation includes an operation of continuously sliding along a first direction after pressing the icon of the first application program.

In a possible design of the fifteenth aspect, the preset operation includes an operation of continuously sliding along a first direction to a first position of the first interface after pressing the icon of the first application program; and the one or more processors are configured to display, by using the display screen, the interface of the first application program in the first position of the first interface in the overlapping manner in response to the preset operation.

In a possible design of the fifteenth aspect, the memory is further configured to store a historical display record about displaying the interface of the first application program on the first interface in the overlapping manner, where the historical display record includes a display size and a display position of the interface of the first application program; and the one or more processors are further configured to display, by using the display screen, the interface of the first application program on the first interface in the overlapping manner based on the historical display record in response to the preset operation.

According to a sixteenth aspect, an electronic device is provided, and includes a display screen, an input device, one or more processors, and a memory that are interconnected by using a bus, where the memory is configured to store one or more programs, and the one or more programs include an instruction; the display screen is configured to display an interface of a first application program and a recent task list, where the recent task list includes an icon of at least one second application program; the input device is configured to receive a preset operation performed by a user on an icon of a target second application program in the recent task list, where the preset operation is used to trigger starting of the target second application program; and the one or more processors are configured to display, by using the display screen, an interface of the target second application program in response to the preset operation, and add the first application program to the recent task list, where
the preset operation includes an operation of tapping or multi-tapping the icon of the target second application program, an operation of pressing the icon of the target second application program, and an operation of dragging the icon of the target second application program to the interface of the first application program after pressing the icon.

According to a seventeenth aspect, an electronic device is provided, and includes a display screen, an input device, one or more processors, and a memory that are interconnected by using a bus, where the memory is configured to store one or more programs, and the one or more programs include an instruction; the display screen is configured to display a first interface and a second interface on split screens, where the first interface is an interface of a first application program, and the second interface is an interface of a second application program; the input device is configured to receive a sliding operation of continuously sliding from a first position of a division line between the first interface and the second interface along the division line to a second position of the division line by a user; and the one or more processors are configured to display, by using the display screen, an interface of a target application program in response to the sliding operation, where the target application program is one of the first application program and the second application program.

According to an eighteenth aspect, an electronic device is provided, and includes a display unit, configured to display icons of a first quantity of application programs; and a receiving unit, configured to receive a preset operation triggered by a user on icons of a second quantity of application programs among the icons of the first quantity of application programs, where the display unit is further configured to display interfaces of the second quantity of application programs in different display areas in response to the preset operation, where the second quantity is greater than or equal to two and less than or equal to the first quantity; and
the preset operation includes any one of the following operations: an operation of tapping the icons of the second quantity of application programs, an operation of multi-tapping the icons of the second quantity of application programs, an operation of pressing the icons of the second quantity of application programs, a first sliding operation of continuously sliding along a first direction after pressing the icons of the second quantity of application programs, and a second sliding operation of continuously sliding along a second direction to the icons of the second quantity of application programs after pressing any point other than the icons of the second quantity of application programs.

In a possible design of the eighteenth aspect, the second quantity of application programs includes a first application program and a second application program; the first application program is a first type of preset application program or a first preset application program, and the second application program is a second type of preset application program or a second preset application program; and the display unit is further configured to display an interface of the first application program and an interface of the second application program separately in different display areas in response to the preset operation, where a display proportion of the interface of the first application program on the display unit is greater than a display proportion of the interface of the second application program on the display unit.

In a possible design of the eighteenth aspect, the second quantity of application programs includes a first application program and a second application program; the electronic device further includes a storage unit, configured to store a historical screen splitting record about displaying the first application program and the second application program on split screens, where the historical screen splitting record includes relative positions of the first application program and the second application program and display proportions of the first application program and the second application program on the display unit of the electronic device; and the display unit is further configured to display an interface of the first application program and an interface of the second application program separately in different display areas based on the historical screen splitting record in response to the preset operation.

According to a nineteenth aspect, an electronic device is provided, and includes a display unit, configured to display icons of a first quantity of application programs; and a receiving unit, configured to receive a first operation performed by a user on an icon of a first application program, where the display unit is configured to display a first interface and a second interface separately in different display areas of the display unit in response to the first operation, where
the first interface is an interface of the first application program, the second interface is used to display icons of a second quantity of application programs, and the second quantity is less than the first quantity; and
the first operation includes any one of the following operations: an operation of tapping the icon of the first application program by using a plurality of fingers, an operation of double-tapping the icon of the first application program, an operation of pressing the icon of the first application program, a first sliding operation of continuously sliding along a first direction after pressing the icon of the first application program, and a second sliding operation of continuously sliding along a second direction to the icon of the first application program after pressing any point other than the icon of the first application program.

In a possible design of the nineteenth aspect, a display proportion of the first interface on the display screen is greater than a display proportion of the second interface on the display screen.

In a possible design of the nineteenth aspect, the electronic device further includes a storage unit, configured to store a historical screen splitting record corresponding to the first application program, where the historical screen splitting record is used to record at least one second application program displayed with the first application program on split screens in a historical screen splitting operation of the user; and the second quantity of application programs includes the at least one second application program recorded in the historical screen splitting record.

In a possible design of the nineteenth aspect, the receiving unit is further configured to receive a second operation performed by the user on a target second application program on the second interface, where the second operation is used to trigger the electronic device to start the target second application program; and the display unit is further configured to display the interface of the first application program and an interface of the target second application program separately in different display areas in response to the second operation.

According to a twentieth aspect, an electronic device is provided, and includes a display unit, configured to display a first interface, where the first interface is an interface of a first application program; and a receiving unit, configured to receive a preset operation performed by a user on the first interface, where the display unit is further configured to display the first interface and a second interface separately in different display areas in response to the preset operation, where the second interface is used to display an icon of at least one second application program; and the preset operation includes a sliding operation triggered when a touch area between the user and the first interface is greater than a first threshold.

According to a twenty-first aspect, an electronic device is provided, and includes a display unit, configured to display a first interface, where the first interface is an interface of a first application program; and a receiving unit, configured to receive a voice instruction input by a user, where □the display unit i [symbol] further configured to display the first interface and a second interface separately in different display areas in response to the voice instruction.

In a possible design of the twenty-first aspect, the voice instruction is used to indicate a second application program to be displayed with the first application program on split screens; and the display unit is further configured to display the interface of the first application program and an interface of the second application program separately in different display areas in response to the voice instruction.

In a possible design of the twenty-first aspect, the voice instruction is used to instruct the electronic device to enable a screen splitting function; and the display unit is further configured to display the interface of the first application program and the second interface separately in different display areas in response to the voice instruction, where the second interface displays an icon of at least one second application program.

In a possible design of the twenty-first aspect, the receiving unit is further configured to receive a second operation performed by the user on an icon of a target second application program in the at least one second application program, where the second operation is used to trigger starting of the target second application program; and the display unit is further configured to display the interface of the first application program and an interface of the target second application program separately in different display areas in response to the second operation.

According to a twenty-second aspect, an electronic device is provided, and includes a display unit, configured to display a first interface, where the first interface displays an icon of at least one application program; and a receiving unit, configured to receive a preset operation performed by a user on an icon of a first application program in the at least one application program, where the display unit is further configured to display an interface of the first application program on the first interface in an overlapping manner in response to the preset operation, where the preset operation includes an operation of continuously sliding along a first direction after pressing the icon of the first application program.

In a possible design of the twenty-second aspect, the preset operation includes an operation of continuously sliding along a first direction to a first position of the first interface after pressing the icon of the first application program; and the display unit is further configured to display the interface of the first application program in the first position of the first interface in the overlapping manner in response to the preset operation.

In a possible design of the twenty-second aspect, the electronic device further includes a storage unit, configured to store a historical display record about displaying the interface of the first application program on the first interface in the overlapping manner, where the historical display record includes a display size and a display position of the interface of the first application program; and
the display unit is further configured to display the interface of the first application program on the first interface in the overlapping manner based on the historical display record in response to the preset operation.

According to a twenty-third aspect, an electronic device is provided, and includes a display unit, configured to display an interface of a first application program and a recent task list, where the recent task list includes an icon of at least one second application program; and a receiving unit, configured to receive a preset operation performed by a user on an icon of a target second application program in the recent task list, where the preset operation is used to trigger starting of the target second application program, where the display unit is further configured to display an interface of the target second application program in response to the preset operation, and display an icon of the first application program in the recent task list, where
the preset operation includes an operation of tapping or multi-tapping the icon of the target second application program, an operation of pressing the icon of the target second application program, and an operation of dragging the icon of the target second application program to the interface of the first application program after pressing the icon.

According to a twenty-fourth aspect, an electronic device is provided, and includes a display unit, configured to display a first interface and a second interface in different display areas, where the first interface is an interface of a first application program, and the second interface is an interface of a second application program; and a receiving unit, configured to receive a sliding operation of continuously sliding from a first position of a division line between the first interface and the second interface along the division line to a second position of the division line by a user, where the display unit is further configured to display an interface of a target application program in response to the sliding operation, where the target application program is one of the first application program and the second application program.

According to a twenty-fifth aspect, a computer-readable storage medium is provided, where the computer-readable storage medium stores an instruction, and when the instruction is run on a computer, the computer is enabled to perform the method in any one of the first aspect to the eleventh aspect.

According to a twenty-sixth aspect, a computer program product is provided, where the computer program product includes an instruction, and when the instruction is run on a computer, the computer is enabled to perform the method in any one of the first aspect to the eleventh aspect.

### DESCRIPTION OF DRAWINGS

FIG. 1-1 and FIG. 1-2 are a schematic diagram of a screen splitting process according to the prior art;

FIG. 2 is a schematic structural diagram of a mobile phone;

FIG. 3 is a schematic flowchart of a multi-task operation method according to an embodiment of this application;

FIG. 3a, FIG. 3b, FIG. 3c, and FIG. 3d are schematic diagrams of interfaces of an electronic device in a locked state to which a multi-task operation method according to an embodiment of this application is applied;

FIG. 4 is a schematic flowchart of a multi-task operation method according to an embodiment of this application when the method is applied to a scenario in which an electronic device displays a home screen;

FIG. 4a and FIG. 4b are schematic diagrams of interfaces of an electronic device performing the method shown in FIG. 4 when the method is applied to a scenario in which the electronic device displays a home screen;

FIG. 5 is a schematic flowchart of another multi-task operation method according to an embodiment of this application when the method is applied to a scenario in which an electronic device displays a home screen;

FIG. 5a and FIG. 5b are schematic diagrams of interfaces of an electronic device performing the method shown in FIG. 5 when the method is applied to a scenario in which the electronic device displays a home screen;

FIG. 6 is a schematic flowchart of a multi-task operation method

according to an embodiment of this application when the method is applied to a scenario in which an electronic device displays an interface of an application program;

FIG. 6a is a schematic diagram of an interface of an electronic device performing the method shown in FIG. 6 when the method is applied to a scenario in which the electronic device displays an interface of an application program;

FIG. 7 is a schematic flowchart of still another multi-task operation method according to an embodiment of this application when the method is applied to a scenario in which an electronic device displays an interface of an application program;

FIG. 7a and FIG. 7b are schematic diagrams of interfaces of an electronic device performing the method shown in FIG. 7 when the method is applied to a scenario in which the electronic device displays an interface of an application program;

FIG. 8 is a schematic flowchart of another multi-task operation method according to an embodiment of this application when the method is applied to a scenario in which an electronic device displays a home screen;

FIG. 8a is a schematic diagram of an interface of an electronic device performing the method shown in FIG. 8 when the method is applied to a scenario in which the electronic device displays a home screen;

FIG. 9 is a schematic flowchart of a method for adjusting positions of interfaces of a plurality of application programs according to an embodiment of this application when an electronic device displays interfaces of a plurality of application programs on split screens;

FIG. 9a is a schematic diagram of an interface of an electronic device performing the method shown in FIG. 9;

FIG. 9b is a schematic diagram of an interface of an electronic device performing another method for adjusting positions of interfaces of a plurality of application programs;

FIG. 10a and FIG. 10b are schematic diagrams of interfaces when a plurality of application programs are displayed on split screens;

FIG. 11 is a schematic flowchart of still another multi-task operation method according to an embodiment of this application;

FIG. 11a-1 to FIG. 11a-3 are a schematic diagram of an interface of an electronic device performing the method shown in FIG. 11;

FIG. 12 is a schematic flowchart of a method for exiting screen splitting according to an embodiment of this application;

FIG. 12a and FIG. 12b are schematic diagrams of interfaces of an electronic device performing the method shown in FIG. 12; and

FIG. 13, FIG. 13a, and FIG. 13b are schematic structural diagrams of an electronic device according to an embodiment of this application.

### DESCRIPTION OF EMBODIMENTS

The terms “first” and “second” mentioned below are intended merely for a purpose of description, and shall not be understood as an indication or implication of relative importance or as an implicit indication of a quantity of indicated technical features. Therefore, a feature defined by “first” or “second” may explicitly or implicitly include one or more features. In the description of the embodiments of this application, unless otherwise specified, “a plurality of” means two or more than two.

A multi-task technology means that an electronic device may run a plurality of application programs (which may also be referred to as applications for short) at a same time. Each application program is referred to as a task. The multi-task technology may be specifically reflected as a screen splitting technology and a picture-in-picture (Picture-in-Picture, PIP) technology. Screen splitting means that interfaces of different application programs may be displayed in different display areas of a display screen of an electronic device, and that interfaces of different application programs do not overlap each other. For example, interfaces of different application programs are displayed separately, so that a user can operate a plurality of application programs simultaneously. The picture-in-picture technology means that after a first interface is displayed, a second interface is displayed on the first interface in an overlapping manner.

An embodiment of this application provides a multi-task operation method, where the method may be applied to an electronic device. For example, the electronic device in this embodiment of this application may be a mobile phone, a tablet computer, a wearable device, an augmented reality (augmented reality, AR) or virtual reality (virtual reality, VR) device, a notebook computer, an ultra-mobile personal computer (ultra-mobile personal computer, UMPC), a netbook, or a personal digital assistant (personal digital assistant, PDA). This is not limited in this embodiment of this application.

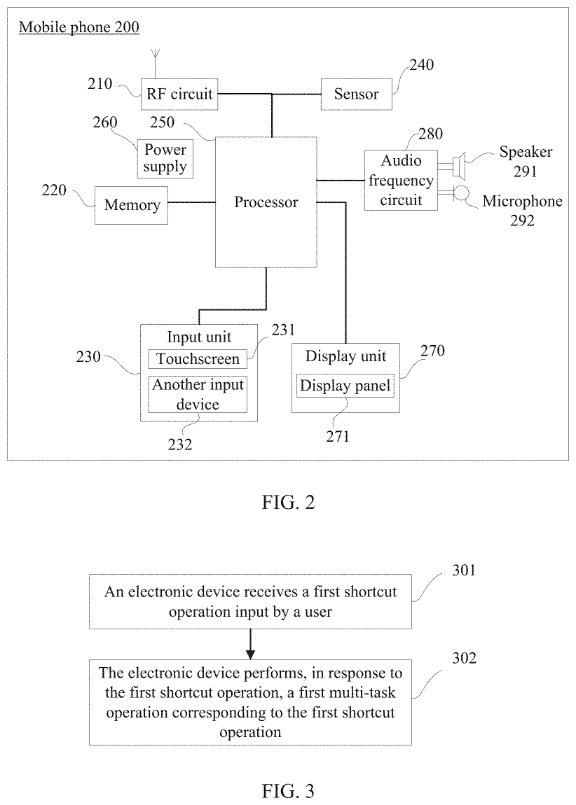

For example, the electronic device is a mobile phone. As shown in FIG. 2, the mobile phone 200 includes components such as a radio frequency (radio frequency, RF) circuit 210, a memory 220, an input unit 230, one or more sensors 240, a processor 250, a power supply 260, a display unit 270, and an audio frequency circuit 280. A person skilled in the art may understand that, a structure of the mobile phone shown in FIG. 2 does not constitute a limitation on the mobile phone. A quantity of components included may be greater or less than that shown in the figure, or some components are combined, or component arrangements are different.

The following describes each functional component of the mobile phone 200.

The RF circuit 210 may be configured to transmit and receive signals in an information transmission or reception or call process, and in particular, after receiving downlink information from a base station, transmit the downlink information to the processor 250 for processing, and in addition, transmit uplink data to the base station. Generally, the RP circuit 210 includes but is not limited to an antenna, at least one amplifier, a transceiver, a coupler, a low noise amplifier (low noise amplifier, LNA), a duplexer, or the like. In addition, the RP circuit 210 may further communicate with a network and other devices through wireless communication. The wireless communication may use any communication standard or protocol, including but not limited to the global system for mobile communication (global system of mobile communication, GSM), general packet radio service (general packet radio service, GPRS), code division multiple access (code division multiple access, CDMA), wideband code division multiple access (wideband code division multiple access, WCDMA), long term evolution (long term evolution, LTE), e-mail, short message service (short messaging service, SMS), or the like.

The memory 220 may be configured to store a software program and module. The processor 250 executes various functional applications and data processing of the mobile phone 200 by running the software program and module stored in the memory 220. The memory 220 may mainly include a program storage area and a data storage area. The program storage area may store an operating system, an application program (Application, APP) required by at least one function, such as an audio playing function or an image playing function. The data storage area may store data (such as audio data, image data, or a phone book) created according to usage of the mobile phone 200, or the like. In addition, the memory 220 may include a high-speed random access memory, and may further include a non-volatile memory, for example, at least one magnetic disk storage device, a flash memory, or another volatile solid-state storage device.

The input unit 230 may be configured to receive digit or character information input by a user, and generate a key signal input related to a user setting and function control of the mobile phone 200. Specifically, the input unit 230 may include a touchscreen 231 and another input device 232. The touchscreen 231, also referred to as a touch panel, may capture a touch operation of the user on or near the touchscreen (for example, an operation performed by the user by using any appropriate object or accessory such as a finger or a stylus on the touchscreen 231 or near the touchscreen 231), and drive a corresponding connection apparatus according to a preset program. Optionally, the touchscreen 231 may include two parts: a touch detection apparatus and a touch controller. The touch detection apparatus detects a touch direction of the user, detects a signal generated by the touch operation, and transmits the signal to the touch controller. The touch controller receives touch information from the touch detection apparatus, converts the touch information into touch point coordinates, and transmits the touch point coordinates to the processor 250, and can receive a command transmitted by the processor 250 and execute the command. In addition, the touchscreen 231 may be implemented by using a plurality of types such as resistive, capacitive, infrared, and surface acoustic wave. In addition to the touchscreen 231, the input unit 230 may further include the another input device 232. Specifically, the another input device 232 may include but is not limited to one or more of a physical keyboard, a function key (such as a volume control key or a power on/off key), a trackball, a mouse, a joystick, or the like.

The sensors 240 include sensors configured to recognize biological features, such as a fingerprint recognition sensor, a facial recognition sensor, and an iris recognition sensor. Using the fingerprint recognition sensor as an example, the fingerprint recognition sensor can capture fingerprint information of the user and report the captured fingerprint information to the processor 250, and the processor 250 recognizes an identity of the user based on the fingerprint information.

The sensors 240 further include a gravity sensor (gravity sensor), which may detect a value of acceleration of the mobile phone in each direction (generally tri-axis), may detect a value and a direction of gravity when the mobile phone is motionless, and may be used in a posture recognition application of the mobile phone (for example, switching between landscape orientation and portrait orientation, a related game, or magnetometer posture calibration), a function related to vibration recognition (for example, a pedometer or a stroke), or the like.

The mobile phone 200 may further include other sensors, for example, light sensors. Specifically, the light sensors may include an ambient light sensor and an optical proximity sensor. The ambient light sensor may adjust luminance of the display panel 231 based on brightness of ambient light. The optical proximity sensor may detect whether an object approaches or touches the mobile phone, and may turn off and/or backlight the display panel 231 when the mobile phone 200 moves to an ear. Other sensors such as a gyroscope, a barometer, a hygrometer, a thermometer, and an infrared sensor may also be configured for the mobile phone 200. Details are not described herein.

The display unit 270 may be configured to display information input by the user or information provided for the user and various menus of the mobile phone 200. The display unit 270 may include a display panel 271. Optionally, the display panel 271 may be configured in a form of a liquid crystal display (Liquid Crystal Display, LCD), an organic light-emitting diode (Organic Light-Emitting Diode, OLED), or the like. Further, the touchscreen 231 may cover the display panel 271. After the touchscreen 231 detects a touch operation on or near the touchscreen, the touchscreen 231 transmits the touch operation to the processor 250 to determine a type of a touch event. Then the processor 250 provides a corresponding visual output on the display panel 271 based on the type of the touch event. Although the touchscreen 231 and the display panel 271 are used as two independent components to implement input and output functions of the mobile phone 200 in FIG. 2, the touchscreen 231 and the display panel 271 may be integrated to implement the input and output functions of the mobile phone 200 in some embodiments.

The audio frequency circuit 280, a speaker 291, and a microphone 292 may provide an audio interface between the user and the mobile phone 200. The audio frequency circuit 280 may convert received audio data into an electrical signal and then transmit the electrical signal to the speaker 291, and the speaker 291 converts the electrical signal into a sound signal for outputting. On the other hand, the microphone 292 converts a captured sound signal into an electrical signal, and the audio frequency circuit 280 converts the received electrical signal into audio data and then outputs the audio data to the RF circuit 210; and then the audio data is transmitted to another mobile phone, or the audio data is output to the memory 220 for further processing.

The processor 250 is a control center of the mobile phone 200. The processor 250 is connected to all parts of the entire mobile phone by using various interfaces and lines, and executes various functions and data processing of the mobile phone 200 by running or executing the software program and/or module stored in the memory 220 and invoking data stored in the memory 220, thereby performing overall monitoring on the mobile phone. Optionally, the processor 250 may include one or more processing units. Optionally, the processor 250 may integrate an application processor and a modern processor. The application processor mainly processes the operating system, a user interface, an application program, or the like. The modem processor mainly processes wireless communication. It may be understood that, alternatively, the modem processor may not be integrated with the processor 250.

The mobile phone 200 further includes the power supply 260 (such as a battery) supplying power to each component. Optionally, the power supply may be logically connected to the processor 250 by using a power management system, so that functions such as charge and discharge management and power consumption management are implemented by using the power management system.

Although not shown, the mobile phone 200 may further include an antenna, a Wireless Fidelity (Wireless Fidelity, Wi-Fi) module, a near field communication (Near Field Communication, NFC) module, a Bluetooth module, a speaker, an accelerometer, a gyroscope, or the like.

The multi-task operation method provided by this embodiment of this application may be applied to any electronic device including the mobile phone shown in FIG. 2.

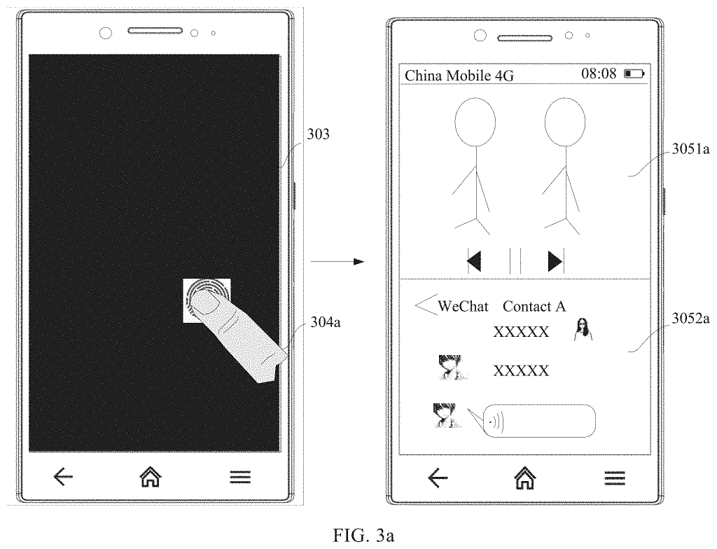

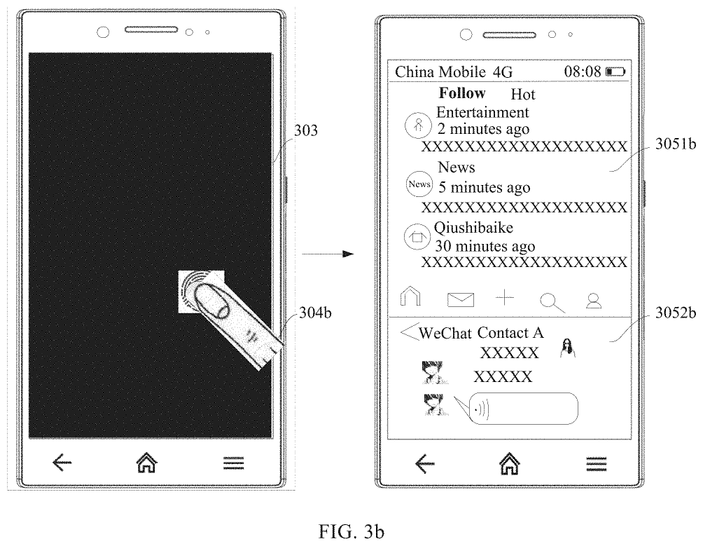

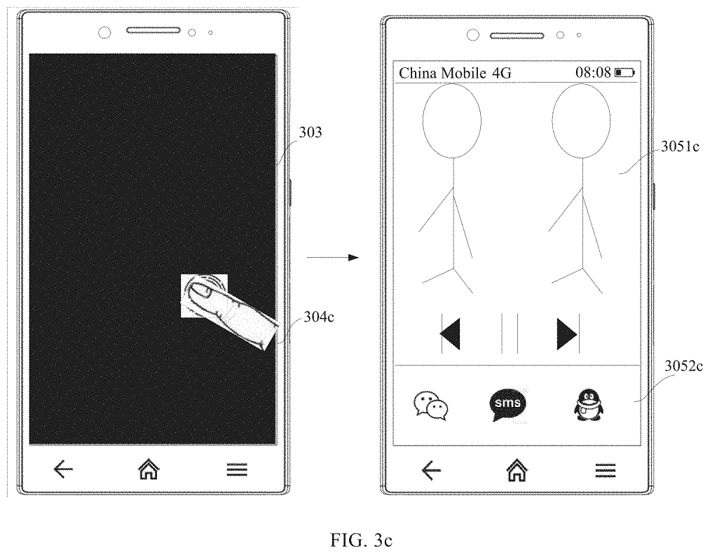

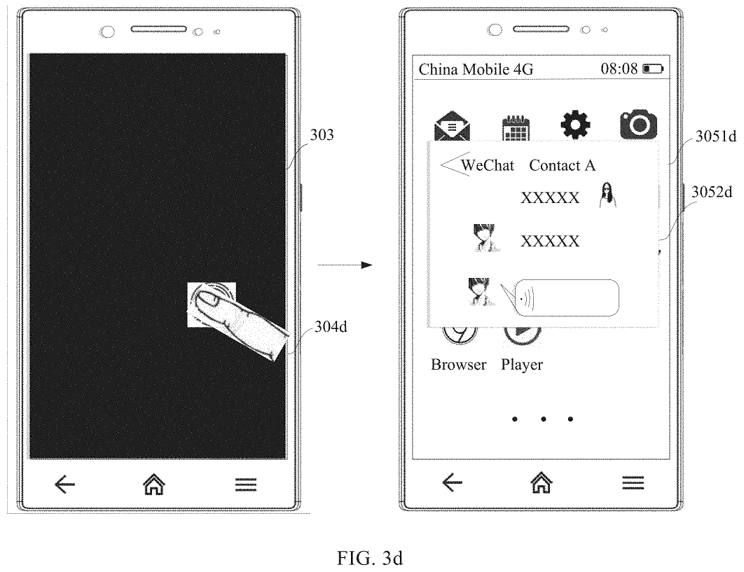

Referring to FIG. 3, an embodiment of this application provides a multi-task operation method, including the following steps:

301. An electronic device receives a shortcut operation input by a user.

The shortcut operation includes a shortcut operation such as inputting a fingerprint or a preset gesture by the user when the electronic device is in a locked state. The shortcut operation further includes a shortcut operation performed by the user on an icon of an application program displayed on an unlocked home screen after the electronic device is unlocked. The shortcut operation further includes a shortcut operation performed by the user in a started application program after the user starts the application program.

302. The electronic device performs, in response to the shortcut operation, a multi-task operation corresponding to the shortcut operation.

The multi-task operation includes a screen splitting operation and a PIP operation. The screen splitting operation includes any screen splitting form such as up-down screen splitting, left-right screen splitting, or screen splitting in a form of a diagonal.

In the multi-task operation method provided by this embodiment of this application, after the electronic device detects the shortcut operation input by the user, the electronic device performs the corresponding multi-task operation.

With reference to an actual application scenario, the following describes in detail the method provided by this embodiment of this application.

The method provided by this embodiment of this application may be applied to an application scenario in which the electronic device is locked. In this application scenario, the multi-task operation method provided by this embodiment of this application may be specifically implemented as follows:

Optionally, in an implementation, the electronic device captures an operation habit of the user in multi-task operations in advance, and obtains one or more multi-task operations commonly used by the user. In addition, with reference to the multi-task operations commonly used by the user, the electronic device pre-establishes one or more correspondences between shortcut operations and the multi-task operations commonly used by the user. Therefore, when the electronic device detects a shortcut operation input by the user, the electronic device performs a multi-task operation corresponding to the shortcut operation.

When the multi-task operation is a screen splitting operation, the screen splitting operation habit captured by the electronic device includes: which applications are usually displayed by the user on split screens, a display position of each application displayed on a split screen on a display screen, a quantity of historical times that the split-screen displaying is performed, or the like.

For example, the screen splitting operation habit includes: the user usually displays an application A and an application B on split screens; the user usually displays an application C and an application D on split screens; or the user usually displays an application A and another application on split screens. For another example, the screen splitting operation habit includes: the user usually displays an application A and an application B on split screens, a display position of the application A on the display screen is a position near an upper edge of the display screen, a proportion of the display screen occupied by the application A is 0.6, a display position of the application B on the display screen is a position near a lower edge of the display screen, and a proportion of the display screen occupied by the application B is 0.4. For another example, the screen splitting operation habit further includes: the user usually displays an application A and an application B on split screens, and average display duration of the screen splitting operation is one hour.

When the multi-task operation is a PIP operation, a PIP operation habit of the user that is captured by the electronic device includes: an application usually displayed on the screen by the user, and a position in which the application is usually placed on the screen for displaying. For example, the user usually places a video application A in a middle position of the screen for displaying by using a size of a length x1 and a width y1. The user usually places a chat application B in an upper position of the screen for displaying by using a size of a length x2 and a width y2.

After the multi-task operation habit of the user is captured, different correspondences between shortcut operations and multi-task operations are established. Therefore, when the user inputs a first shortcut operation on a locked screen interface, the electronic device performs a first multi-task operation; and when the user inputs a second shortcut operation on the locked screen interface, the electronic device performs a second multi-task operation. The first shortcut operation and the second shortcut operation include: inputting a biological recognition feature such as a fingerprint or inputting a gesture by the user on the locked screen interface of the electronic device, pressing a shortcut key, and the like. The first shortcut operation is different from the second shortcut operation.

For example, referring to FIG. 3a, the user inputs a first fingerprint 304a on a locked screen interface 303 of the mobile phone. After the mobile phone detects the first fingerprint 304a, the mobile phone is unlocked and displays a video interface 3051a and a WeChat interface 3052a on split screens. The video interface 3051a and the WeChat interface 3052a occupy 50% of the entire display screen respectively.

Referring to FIG. 3b, the user inputs a second fingerprint 304b on the locked screen interface 303 of the mobile phone. After the mobile phone detects the second fingerprint 304b, the mobile phone is unlocked and displays a microblog interface 3051b and a WeChat interface 3052b on split screens. The microblog interface 3051b is located in an upper area near the upper edge of the display screen, the WeChat interface 3052b is located in a lower area near the lower edge of the display screen, and display proportions of the microblog interface 3051b and the WeChat interface 3052b on the display screen of the electronic device are 60% and 40% respectively.

In another implementation, when the user inputs a fingerprint on the locked screen interface of the mobile phone, the mobile phone is unlocked and displays an interface of a first application and an icon of another application. The first application is an application that is usually displayed by the user on a split screen and obtained based on a historical screen splitting habit of the user. The another application is any other application supporting the screen splitting function than the first application. Alternatively, the another application may be one or more applications associated with the first application. Specifically, the another application associated with the first application is one or more applications that are usually displayed by the user with the first application on split screens and obtained based on the operation habit of the user. Alternatively, the another application is another application that may be used by the user in a process of using the first application. For example, when the first application is a WeChat application, considering that the user may share a picture, music, or the like with a contact in the WeChat, the interface of the WeChat application and icons of applications such as a gallery and music are displayed on split screens.

For example, referring to FIG. 3c, the user inputs a third fingerprint 304c on the locked screen interface 303 of the mobile phone. After detecting the third fingerprint 304c, the mobile phone displays an interface 3051c of the video application and a second interface 3052c, where the interface 3052c displays icons of applications such as WeChat, QQ, and SMS.

Referring to FIG. 3d, the user inputs a fourth fingerprint 304d on the locked screen interface 303. After detecting the fourth fingerprint 304d, the mobile phone is unlocked and displays an unlocked interface 3051d. In addition, an interface 3052d of the WeChat application is displayed on the unlocked interface 3051d in an overlapping manner. To be specific, the interface 3052d of the WeChat application is displayed on the unlocked interface 3051d in a picture-in-picture manner.

It should be noted that, the foregoing application is only an example, and may be any application in an actual operation. In addition, in the foregoing figures, an example in which a fingerprint recognition area is located within the display screen is used for description. In an actual application, the fingerprint recognition area may be further located outside the display screen, for example, a back of the mobile phone or a Home key.

Considering that the display screen of the mobile phone includes a plurality of fingerprint recognition areas in an actual application. Therefore, in another implementation, the method provided by this embodiment of this application may be further implemented as follows: When the mobile phone detects a fingerprint input by the user in a first fingerprint recognition area, after fingerprint verification succeeds, the electronic device performs a first multi-task operation. When the mobile phone detects a fingerprint input by the user in a second fingerprint recognition area, after fingerprint verification succeeds, the electronic device performs a second multi-task operation.

In another implementation, alternatively, the shortcut operation may be a shortcut gesture operation in addition to the fingerprint operation. For example, when the mobile phone detects a first gesture input by the user on the locked screen interface, the mobile phone is unlocked and performs a first screen splitting operation. When the mobile phone detects a second gesture input by the user on the locked screen interface, the mobile phone is unlocked and performs a second screen splitting operation. When the mobile phone detects a third gesture input by the user on the locked screen interface, the mobile phone is unlocked and performs a first PIP operation. When the mobile phone detects a fourth gesture input by the user on the locked screen interface, the mobile phone is unlocked and performs a second PIP operation.

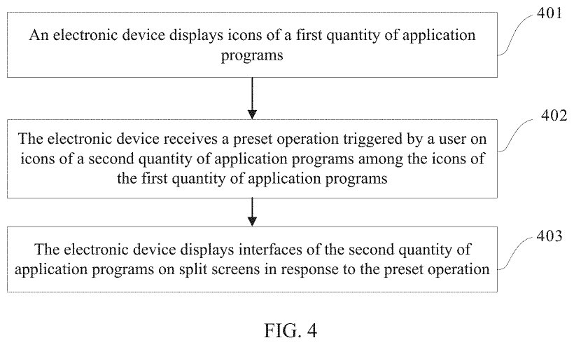

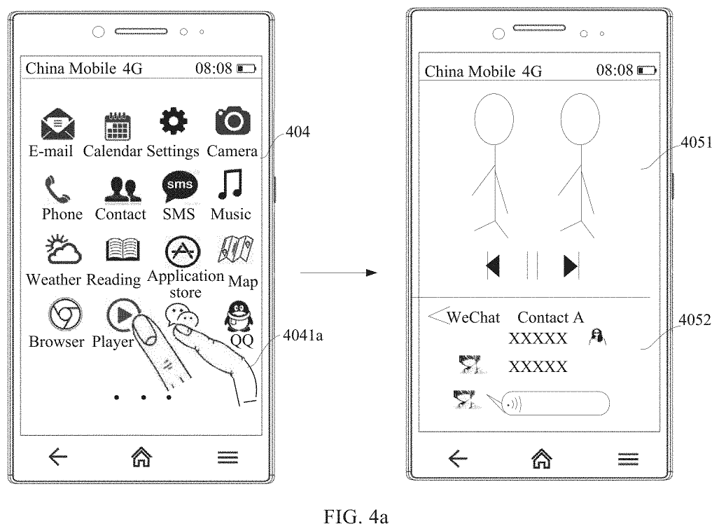

The multi-task operation method provided by this embodiment of this application may be further applied to a scenario in which the electronic device is unlocked and displays the home screen. The home screen in this embodiment of this application is an interface used for displaying icons of all application programs installed on the mobile phone. In this scenario, referring to FIG. 4, a multi-task operation method provided by an embodiment of this application may be specifically implemented as follows:

401. An electronic device displays icons of a first quantity of application programs.

402. The electronic device receives a preset operation triggered by a user on icons of a second quantity of application programs among the icons of the first quantity of application programs.

403. The electronic device displays interfaces of the second quantity of application programs on split screens in response to the preset operation.

The second quantity is greater than or equal to two and less than or equal to the first quantity. Specifically, the second quantity is 2. Alternatively, when the electronic device is an electronic device having a relatively large display screen, such as a personal computer, the second quantity may be further more than 2, for example, 3.

Optionally, the preset operation includes tapping the icons of the second quantity of application programs. Specifically, the tapping operation may be an operation of tapping the icons of the second quantity of application programs in sequence in a preset time interval. The preset time interval is very short, for example, may be several seconds. When an interval of tapping the icons of the second quantity of application programs in sequence is very short, it may be considered that the user taps the icons of the second quantity of application programs simultaneously. For example, the electronic device displays icons of application programs A, B, C, and D, and the preset operation is specifically that the user taps icons of the application program A and the application program B simultaneously by using different fingers. For another example, the electronic device displays icons of application programs A, B, C, and D, and the preset operation is specifically that the user taps icons of the application program A and the application program B in sequence in a time interval of 20 s by using a same finger.

For example, referring to FIG. 4a, icons of application programs such as “QQ”, “WeChat”, “video”, and “music” are displayed on a home screen 404 of the mobile phone. As shown by 4041a, when the user taps icons of two application programs “WeChat” and “video” simultaneously by using different fingers, the mobile phone displays an interface 4051 of the video application and an interface 4052 of the WeChat application.

The preset operation further includes an operation of multi-tapping the icons of the second quantity of application programs. The multi-tapping means consecutively tapping a plurality of times, including double-tapping, tapping three times, tapping four times, or the like. Specifically, the multi-tapping operation may be an operation of multi-tapping the icons of the second quantity of application programs in sequence in a preset time interval. The preset time interval is very short, for example, may be several seconds. When an interval of multi-tapping the icons of the second quantity of application programs by the user in sequence is very short, it may be considered that the user multi-taps the icons of the second quantity of application programs simultaneously. For example, the electronic device displays icons of application programs A, B, C, and D, and the preset operation is specifically that the user double-taps icons of the application program A and the application program B simultaneously by using different fingers.

The preset operation further includes an operation of pressing the icons of the second quantity of application programs. Specifically, the pressing operation may be an operation of pressing the icons of the second quantity of application programs in sequence in a preset time interval. The preset time interval is very short, for example, may be several seconds. When an interval of pressing the icons of the second quantity of application programs by the user in sequence is very short, it may be considered that the user presses the icons of the second quantity of application programs simultaneously. For example, the electronic device displays icons of application programs A, B, C, and D, and the preset operation is specifically that the user presses icons of the application program A and the application program B simultaneously by using different fingers.

The preset operation further includes a sliding operation. The sliding operation is specifically a first sliding operation of continuously sliding along a first direction after pressing the icons of the second quantity of application programs by the user. Specifically, the first sliding operation may be a sliding operation of continuously sliding along the first direction sequence in a preset time interval after pressing the icons of the second quantity of application programs by the user. The preset time interval is very short, for example, may be several seconds. When a time interval of sliding along the first direction in sequence after pressing the icons of the second quantity of application programs by the user is very short, it may be considered that the user slides along the first direction simultaneously after pressing the icons of the second quantity of application programs. For example, the electronic device displays icons of application programs A, B, C, and D, and the user slides, by using icons of the application program A and the application program B as start points, to a same direction simultaneously after pressing the icons of the application program A and the application program B by using different fingers.

For example, referring to FIG. 4b, icons of application programs such as “QQ”, “WeChat”, “video”, and “music” are displayed on a home screen 404 of the mobile phone. As shown by 4041b, when the user slides down simultaneously after pressing icons of two application programs “WeChat” and “video”, the mobile phone displays an interface 4051 of the video application and an interface 4052 of the WeChat application.

Alternatively, the sliding operation is specifically a second sliding operation of continuously sliding along a second direction to the icons of the second quantity of application programs after pressing any point other than the icons of the second quantity of application programs by the user. The preset time interval is very short, for example, may be several seconds. When the user continuously slides along the second direction to the icons of the second quantity of application programs in sequence in a very short time after pressing any point other than the icons of the second quantity of application programs, it may be considered that the user slides along the second direction to the icons of the application program A and the application program B simultaneously by using any point other than the icons of the second quantity of application programs as a start point. For example, the electronic device displays icons of application programs A, B, C, and D, and the user slides along a specific direction to icons of the application program A and the application program B simultaneously.

In the foregoing method, the electronic device displays the icons of the application programs. When detecting that the user triggers a same operation on icons of two or more of the application programs, the electronic device displays the two or more application programs on split screens. In comparison with the prior art in which a user needs to first start a first application, then slide from an edge of an interface of the first application to enable a screen splitting function, and then select a second application to be displayed with the first application on split screens, after using the method provided by this embodiment of this application, the user can directly perform a shortcut operation on icons of two or more applications on the home screen to display the two or more applications on split screens. Therefore, a split-screen displaying method that is faster and more convenient can be provided.

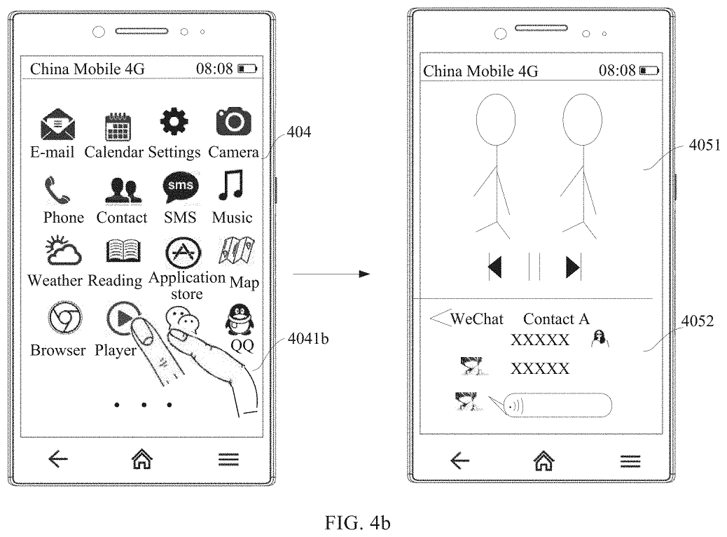

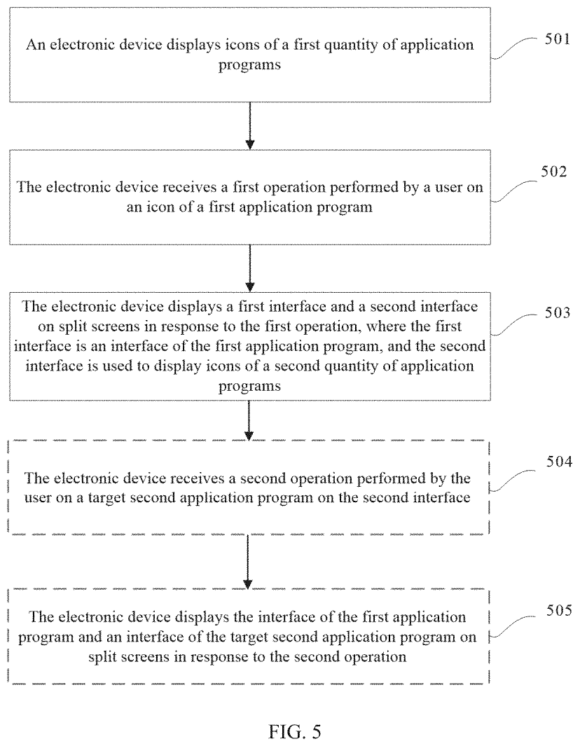

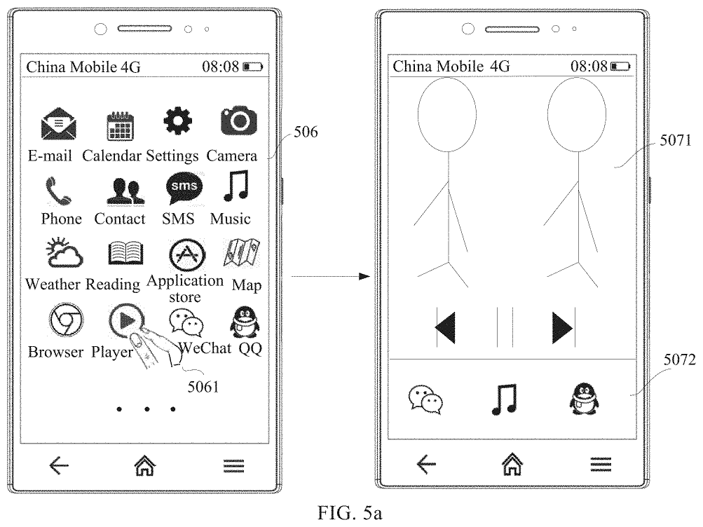

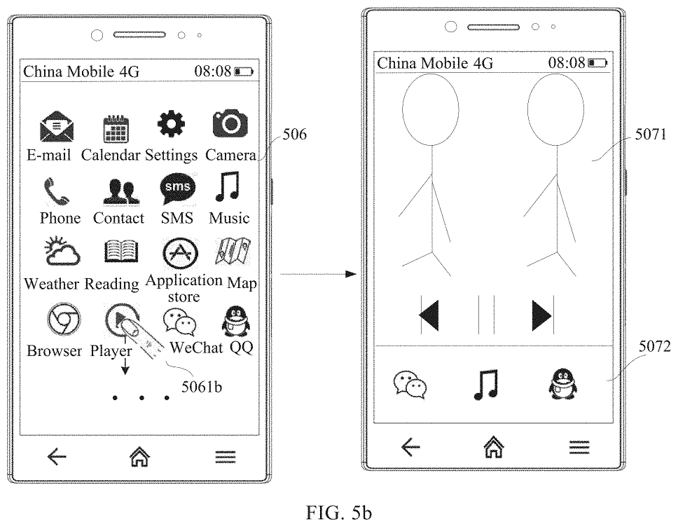

In an application scenario in which an electronic device is unlocked and displays a home screen and the home screen displays icons of a plurality of application programs, referring to FIG. 5, an embodiment of this application provides still another multi-task operation method, including the following steps:

501. An electronic device displays icons of a first quantity of application programs.

502. The electronic device receives a first operation performed by a user on an icon of a first application program.

In this embodiment, the first operation includes an operation of tapping the icon of the first application program by the user by using a plurality of fingers, and further includes an operation of double-tapping the icon of the first application program by the user by using a plurality of fingers. The first operation further includes an operation of multi-tapping the icon of the first application program by the user by using a single finger. The first operation further includes a first sliding operation of sliding along a specific direction to the icon of the first application program by the user by using a plurality of fingers. The first operation further includes a second sliding operation of pressing the icon of the first application program and sliding along a specific direction by the user by using the icon of the first application program as a start point.

503. The electronic device displays a first interface and a second interface on split screens in response to the first operation.

The first interface is an interface of the first application program, and the second interface is used to display icons of a second quantity of application programs.

The second quantity is less than the first quantity. The second quantity of application programs includes other application programs than the first application program in the first quantity of application programs. Specifically, the another application associated with the first application is one or more applications that are usually displayed by the user with the first application on split screens and obtained based on an operation habit of the user. Alternatively, the another application is another application that may be used by the user in a process of using the first application. For example, when the first application is a WeChat application, considering that the user may share a picture, music, or the like with a contact in the WeChat, an interface of the WeChat application and icons of applications such as a gallery and music are displayed on split screens. Alternatively, the icons of the second quantity of application programs are other application programs that currently run in a background of the electronic device.

In the foregoing method, when the electronic device detects the first operation performed by the user on the icon of the first application program, the electronic device displays the interface of the first application program and icons of other application programs on split screens, so that the user can select, from the displayed icons of the other application programs, an application program to be displayed with the first application program on split screens. In comparison with the prior art in which a user needs to first start a first application program, and then perform an operation such as touching and holding a multi-task function key or sliding on an interface of the first application program to enable a screen splitting function and display an icon of another application program, in the method provided by this embodiment of this application, the user does not need to open the interface of the first application program, but can directly trigger a shortcut operation such as the first operation on the icon of the first application program to display icons of other application programs with the interface of the first application program on split screens, and further, the user selects, from the icons of the other application programs, another application program to be displayed with the first application program on split screens.

Optionally, referring to FIG. 5, after the electronic device displays the first interface and the second interface on split screens, the method further includes the following steps:

504. The electronic device receives a second operation performed by the user on a target second application program on the second interface.

The second operation is used to trigger the electronic device to start the target second application program.

505. The electronic device displays the interface of the first application program and an interface of the target second application program on split screens in response to the second operation.

To be specific, after the electronic device displays the first interface and the second interface on split screens, the electronic device receives an operation of selecting a second application program from the second interface and starting the second application program by the user, and further, the electronic device displays the first application program and the second application program on split screens in response to the operation of the user.

Referring to FIG. 5a, icons of application programs such as “QQ”, “WeChat”, “video”, and “music” are displayed on a home screen 506 of the mobile phone. As shown by 5061a, when the user taps an icon of the video application program simultaneously by using two fingers, the mobile phone displays an interface 5071 of the video application and a second interface 5072 on split screens, where icons of other application programs such as “WeChat”, “music”, and “QQ” are displayed on the second interface 5072.

Referring to FIG. 5b, icons of application programs such as “QQ”, “WeChat”, “video”, and “music” are displayed on the home screen 506 of the mobile phone. As shown by 5061b, when the user presses an icon of the video application program, the mobile phone displays an interface 5071 of the video application and a second interface 5072 on split screens, where icons of other application programs such as “WeChat”, “music”, and “QQ” are displayed on the second interface 5072.

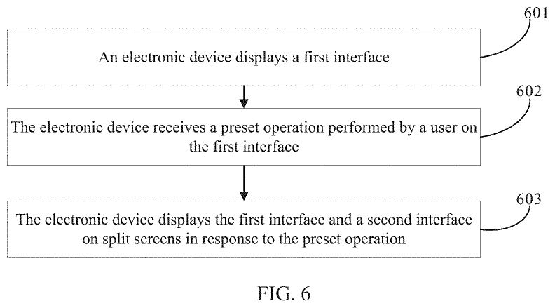

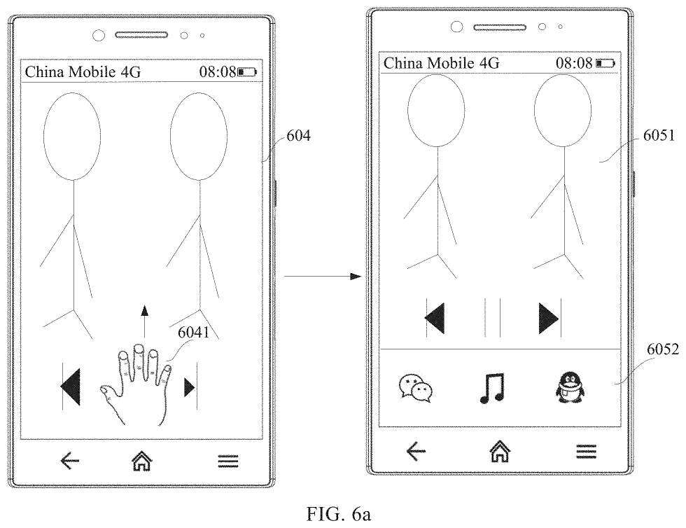

When applied to a scenario in which an electronic device has started an application program, referring to FIG. 6, an embodiment of this application provides yet another multi-task operation method, including the following steps:

601. An electronic device displays a first interface, where the first interface is an interface of a first application program.

602. The electronic device receives a preset operation performed by a user on the first interface.

603. The electronic device displays the first interface and a second interface on split screens in response to the preset operation.

The second interface is used to display an icon of at least one second application program. The preset operation includes a sliding operation of pulling down from an upper edge of the screen, or a sliding operation of pushing up from a lower edge of the screen, where the operation is triggered when a touch area between the user and a display screen of the electronic device is greater than a threshold. For example, the user pushes up from the lower edge of the display screen or pulls down from the upper edge of the display screen by using an entire palm or most of a palm. For another example, when a touch area of a thumb is greater than a threshold or a length of a touch area is greater than a threshold, the second interface displays an icon of one or more other application programs. Alternatively, the second interface displays an interface of another application program.

Referring to FIG. 6a, the mobile phone displays an interface 604 of a video application. As shown by 6041, when the mobile phone detects that the palm of the user touches the mobile phone and pushes up from the lower edge of the screen of the mobile phone, the mobile phone displays an interface 6051 of the video application and a second interface 6052 on split screens, and icons of other application programs such as “WeChat”, “music”, and “QQ” are displayed on the second interface 6052. Further, the user may select, from the icons of the applications displayed on the second interface 6052, an application to be displayed with the video application on split screens.

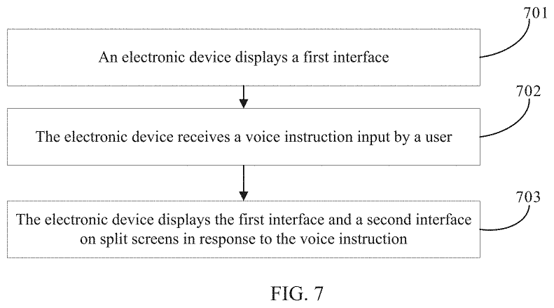

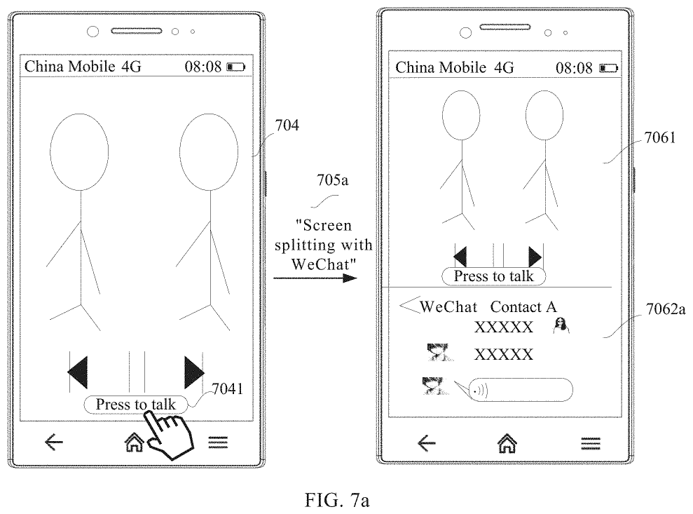

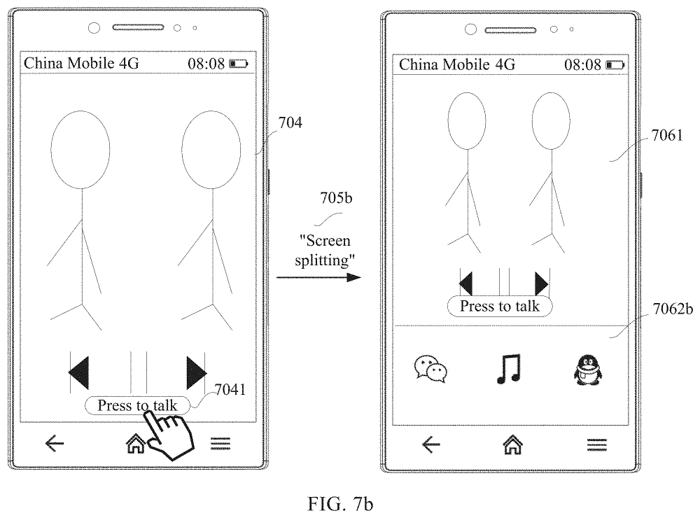

When applied to a scenario in which an electronic device has started an application program, referring to FIG. 7, an embodiment of this application provides yet another multi-task operation method, including the following steps:

701. An electronic device displays a first interface, where the first interface is an interface of a first application program.

702. The electronic device receives a voice instruction input by a user.

703. The electronic device displays the first interface and a second interface on split screens in response to the voice instruction.

The voice instruction is a voice instruction including terms such as “screen splitting”.

Specifically, when the voice instruction is used to indicate a second application program to be displayed with the first application program on split screens, the electronic device displays the interface of the first application program and an interface of the second application program on split screens in response to the voice instruction.

For example, if the voice instruction is a voice instruction “screen splitting to start the second application” or “screen splitting with the second application” input by the user, the electronic device displays, on split screens in response to the voice instruction, the interface of the first application program and the interface of the second application program indicated by the voice instruction. To be specific, the second interface of the electronic device is the interface of the second application.

When the voice instruction is only used to instruct the electronic device to enable a screen splitting function, the electronic device displays the interface of the first application program and the second interface on split screens in response to the voice instruction, where an icon of at least one second application program is displayed on the second interface. After the electronic device displays the interface of the first application program and the second interface on split screens, the electronic device receives a second operation performed by the user on an icon of a target second application program, where the second operation is used to trigger starting of the target second application program. The electronic device displays the interface of the first application program and an interface of the target second application program on split screens in response to the second operation. To be specific, the electronic device receives an operation of selecting and starting the target second application program by the user, and the electronic device displays the first application program and the target second application program on split screens in response to the operation.

For example, if the voice instruction is a voice instruction “screen splitting with desktop” or “screen splitting”, the electronic device enables the screen splitting function and displays the second interface and the first interface on split screens in response to the voice instruction. The second interface is an interface displaying icons of other application programs. Further, the user may select an icon of a second application program from the second interface, and the electronic device displays the first application program and the second application program on split screens.

Optionally, in this embodiment of this application, a voice capture function of the electronic device is always in an enabled state.

Optionally, in this embodiment of this application, after the user starts the first application program, an icon used by the user to enable or disable the voice capture function of the electronic device is displayed on the interface of the first application program, and the user may operate the icon to enable or disable the voice capture function of the electronic device.

Referring to FIG. 7a, the mobile phone displays an interface 704 of a video application. An entry identifier 7041 prompting the user to input a voice is displayed on the interface 704. When the user presses an icon identified by the identifier 7041, the mobile phone may capture a voice instruction input by the user. As shown by 705a, when the user inputs a voice instruction “screen splitting with WeChat”, the mobile phone displays an interface 7061 of the video application and an interface 7062a of the WeChat application on split screens.

Referring to FIG. 7b, as shown by 705b, when the user inputs the voice instruction “screen splitting”, the mobile phone displays the interface 7061 of the video application and a second interface 7062b, where icons of application programs such as WeChat, music, and QQ are displayed on the second interface 7062b.

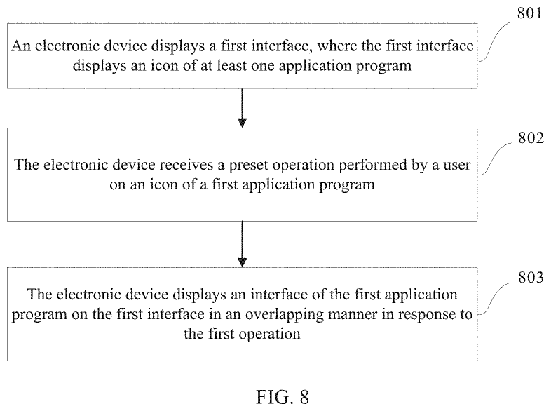

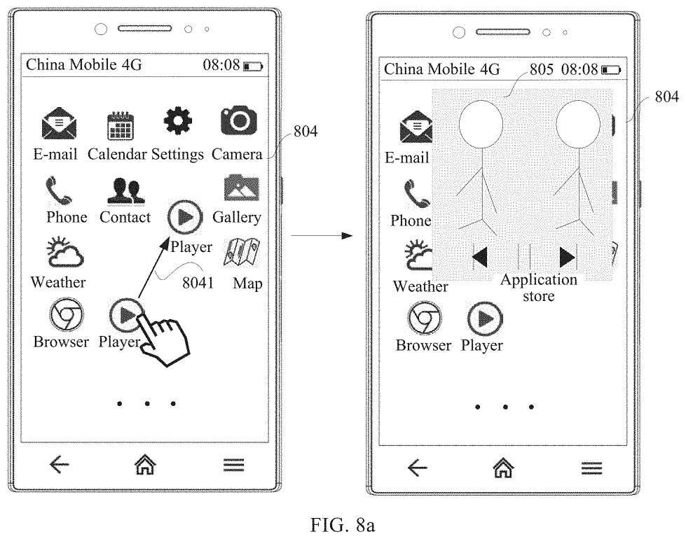

When applied to a scenario in which an electronic device is unlocked and displays a home screen and the home screen displays an icon of an application program, referring to FIG. 8, an embodiment of this application provides yet another multi-task operation method, including the following steps:

801. An electronic device displays a first interface, where the first interface displays an icon of at least one application program.

802. The electronic device receives a preset operation performed by a user on an icon of a first application program.

803. The electronic device displays an interface of the first application program on the first interface in an overlapping manner in response to the preset operation.

In this embodiment, the preset operation is used to trigger the electronic device to display the interface of the first application program in a PIP manner. The preset operation includes an operation of continuously sliding along a first direction after pressing the icon of the first application program. The preset operation further includes an operation such as double-tapping the icon of the first application program.

Optionally, the preset operation in step 802 includes an operation of continuously sliding along the first direction to a first position of the first interface after pressing the icon of the first application program. In this case, a specific implementation of step 803 is: the electronic device displays the interface of the first application program in the first position of the first interface in the overlapping manner.

In the foregoing method, icons of a plurality of application programs are displayed on the home screen of the electronic device. When the electronic device detects an operation of selecting the icon of the first application program from the icons of the plurality of application programs, dragging the icon of the first application program to a position, and then releasing the icon by the user, the electronic device displays the interface of the first application program in the PIP manner.

Referring to FIG. 8a, icons of application programs such as “QQ”, “WeChat”, “video”, and “music” are displayed on a home screen 804 of the mobile phone. As shown by an operation 8041, when the user presses an icon of the video application program and drags the icon to a position near an upper edge of the screen, the mobile phone displays an interface 805 of the video application on the home screen 804 in the overlapping manner. Therefore, the interface of the video application is displayed on the desktop in the PIP manner.

Optionally, the electronic device stores a historical display record about displaying the interface of the first application program on the first interface in the overlapping manner, where the historical display record includes a display size and a display position of the interface of the first application program. Therefore, the interface of the first application program can be displayed on the first interface in the overlapping manner based on the historical display record. In an actual application, after the interface of the first application program is displayed on the first interface in the overlapping manner, a size and a position of the interface of the first application program may be adjusted. Specifically, the user may drag the interface of the first application program to adjust the position of the interface of the first application program. Alternatively, the user may drag an edge of the interface of the first application program to increase or reduce the size of the interface of the first application program.

The method provided by this embodiment of this application can implement fast screen splitting of the electronic device or display the application interface fast in a PIP manner.

After fast screen splitting of the electronic device is implemented, an embodiment of this application further provides an optional implementation of adjusting positions of a plurality of interfaces displayed on split screens.

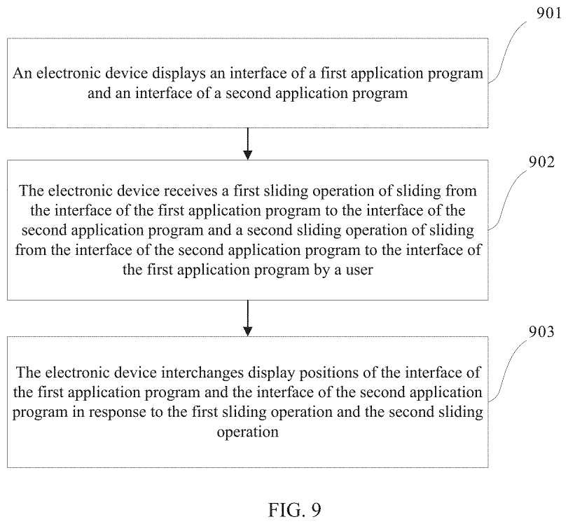

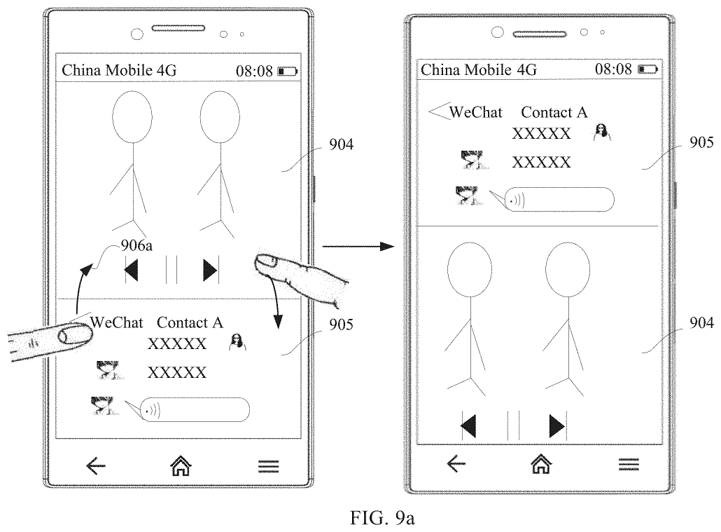

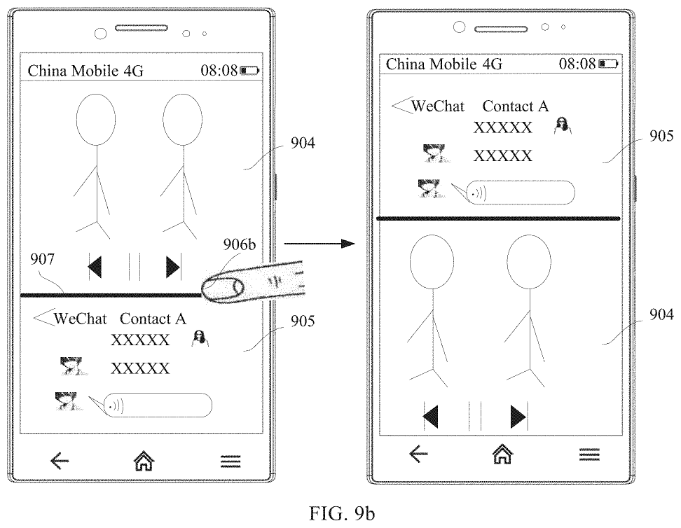

Referring to FIG. 9, an embodiment of this application provides a method for adjusting positions of a plurality of interfaces displayed on split screens, where the method includes the following steps:

901. An electronic device displays an interface of a first application program and an interface of a second application program.

902. The electronic device receives a first sliding operation of sliding from the interface of the first application program to the interface of the second application program and a second sliding operation of sliding from the interface of the second application program to the interface of the first application program by a user.

903. The electronic device interchanges display positions of the interface of the first application program and the interface of the second application program in response to the first sliding operation and the second sliding operation.

The method shown in FIG. 9 can interchange the display interfaces of the first application and the second application.

It should be noted that, in an implementation, only the positions of the first application and the second application are interchanged, and display proportions of the first application and the second application after the interchange remain unchanged. For example, before interchange, a display interface of an application A is located in an area near an upper edge of a screen, a display interface of an application B is located in an area near a lower edge of the screen, a display proportion of the application A is 30%, and a display proportion of the application B is 70%. In this case, after display positions of the application A and the application B are interchanged by using the foregoing method, the display interface of the application B is located in the area near the upper edge of the screen, and the display proportion of the application B is still 70%. The display interface of the application A is located in the area near the lower edge of the screen, and the display proportion of the application A is still 30%. In another implementation, a display screen includes a first display area and a second display area that are fixedly defined; before interchange, the first display area is used to display an application A, and the second display area is used to display an application B; and after the interchange, the first display area is used to display the application B, and the second display area is used to display the application A.

Referring to FIG. 9a, in an optional implementation, when the mobile phone displays an interface of a video application and an interface of a WeChat application on split screens, an interface 904 of the video application is displayed in the area near the upper edge of the display screen; and an interface 905 of the WeChat application is displayed in the area near the lower edge of the display screen. As shown by an operation 906a, when the user slides from the interface 904 of the video application to the interface 905 of the WeChat application and slides from the interface 905 of the WeChat application to the interface 904 of the video application simultaneously by using two different fingers, display positions of the two applications, that is, video and WeChat, are interchanged. To be specific, the interface 905 of the WeChat application is displayed in the area near the upper edge of the display screen, and the interface 904 of the video application is displayed in the area near the lower edge of the display screen.

Referring to FIG. 9b, in another optional implementation, when the mobile phone displays the interface of the video application and the interface of the WeChat application on split screens, the interface 904 of the video application is displayed in the area near the upper edge of the display screen; the interface 905 of the WeChat application is displayed in the area near the lower edge of the display screen; and a division line 907 exists between the interface 904 of the video application and the interface 905 of the WeChat application. As shown by 906b, when the user double-taps or touches and holds the division line 907, display positions of the two applications, that is, video and WeChat, are interchanged. To be specific, the interface 905 of the WeChat application is displayed in the area near the upper edge of the display screen, and the interface 904 of the video application is displayed in the area near the lower edge of the display screen.

After fast screen splitting of the electronic device is implemented by using the foregoing methods, an embodiment of this application further provides several specific implementations of displaying interfaces of a plurality of application programs on split screens.

Optionally, when interfaces of a plurality of application programs are displayed on split screens, the interfaces of the plurality of application programs are displayed at equal proportions by default. For example, when an application program A and an application program B are displayed on split screens, display proportions of the application A and the application B on a display screen of an electronic device are both 50%. To be specific, interfaces of the application A and the application B respectively occupy half of the display screen. For another example, when an application A, an application B, and an application C are displayed on split screens, display proportions of the application A, the application B, and the application C are ⅓ respectively.

Optionally, when the interfaces of the plurality of application programs are displayed on split screens, display proportions of interfaces of different application programs vary according to attributes of the application programs.

For example, when the mobile phone displays a multimedia application such as video or music and a messaging application such as WeChat or QQ on split screens, a display proportion of the multimedia application on the display screen of the electronic device is greater than a display proportion of the messaging application.

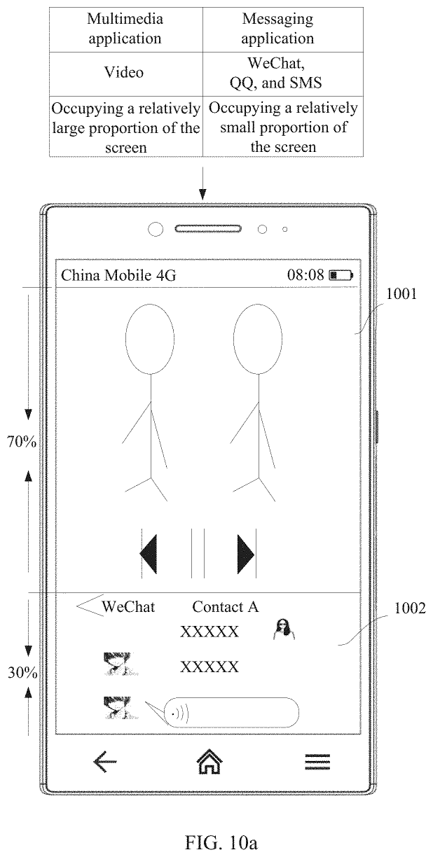

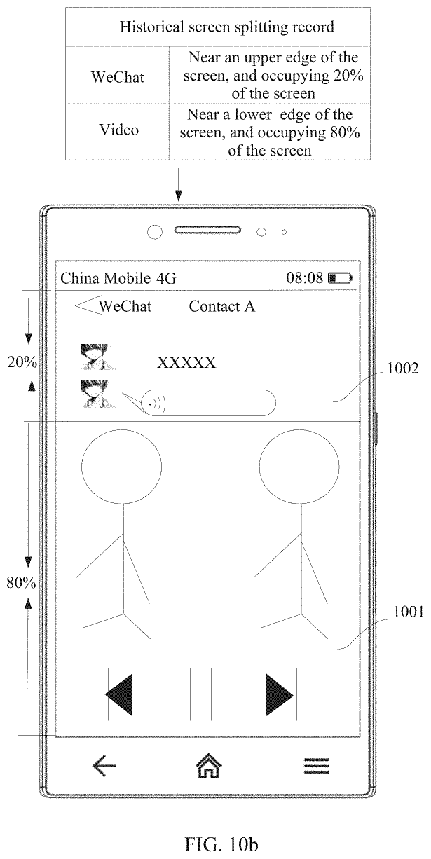

Referring to FIG. 10a, when an interface 1001 of the video application and an interface 1002 of the WeChat application are displayed on split screens, because the video application is a multimedia application, and the WeChat application is a chat application, a display proportion of the interface 1001 of the video application on the display screen of the electronic device is 70%, and a display proportion of the interface 1002 of the WeChat application is 30%.

Optionally, when interfaces of a plurality of application programs are displayed on split screens for the first time, the plurality of application programs are displayed on split screens based on default settings. Using the application A and the application B displayed on split screens as an example, when the two applications are displayed on split screens for the first time, the electronic device displays the two applications symmetrically. To be specific, display proportions of the two applications, that is, the application A and the application B, are both 50%, the application A is located in an area near an upper edge of the display screen of the electronic device, and the application B is located in an area near a lower edge of the display screen of the electronic device. When a user adjusts display positions or display proportions of applications based on a use habit of the user, for example, when the user performs an operation to display the application A in the area near the lower edge of the display screen of the electronic device at the display proportion of 70%, and to display the application B in the area near the upper edge of the display screen of the electronic device at the display proportion of 30%, the electronic device captures and stores the screen splitting habit of the user. Afterward, when the electronic device displays the application A and the application B on split screens again, the electronic device displays the application A and the application B based on the screen splitting habit of the user that is stored by the electronic device.

Therefore, in an implementation, the electronic device captures an operation habit in a screen splitting operation performed by the user, to obtain and store a historical screen splitting parameter of the user. The historical screen splitting parameter includes a screen splitting position and a display proportion of an application, or the like. In this case, when displaying two or more application programs on split screens, the electronic device displays the two or more application programs on split screens based on historical screen splitting parameters of the two or more application programs.

For example, when displaying the application A and the application B on split screens, when the electronic device locally stores historical screen splitting parameters of the application A and the application B displayed on split screens, for example, display positions and display proportions of the application A and the application B on split screens, the electronic device displays the application A and the application B on split screens based on the historical screen splitting parameters.

For another example, when displaying the application A and the application B on split screens, when the electronic device stores a historical screen splitting parameter of only one of the applications, for example, stores a historical screen splitting parameter of only the application A displayed with icons of a plurality of application programs on split screens or displayed with other applications (not including the application B) on split screens, the electronic device displays the application A and the application B on split screens based on the historical screen splitting parameter of the application A.

For another example, when displaying the application A and the application B on split screens, when the electronic device stores historical screen splitting parameters of the application A and other applications (not including the application B) on split screens, and there are historical screen splitting parameters of the application B and other applications (not including the application A) on split screens, but historical screen splitting parameters of the application A and the application B displayed on split screens are not stored, the electronic device displays the application A and the application B on split screens based on a historical screen splitting parameter whose storage time is the latest or a historical screen splitting parameter of an application that appears most frequently. For example, a quantity of times that a historical screen splitting parameter of the application A appears is 5, and a quantity of times that a historical screen splitting parameter of the application B appears is 10, where the quantities of times are stored in a historical screen splitting record about displaying the application A with other applications on split screens and displaying the application B with other applications on split screens. In this case, the application B and the application A are displayed on split screens based on the historical screen splitting record of the application B.

For another example, when displaying the application A and the application B on split screens, when the electronic device stores neither a historical screen splitting parameter of the application A nor a historical screen splitting parameter of the application B, the electronic device displays the application A and the application B on split screens based on default settings.

Referring to FIG. 10b, when the interface 1001 of the video application and the interface 1002 of the WeChat application are displayed on split screens, when the user displays the two applications on split screens based on historical screen splitting parameters, a display habit of the user is as follows: The video application is located in a position near the upper edge of the screen, and a display proportion of the video application is 0.8. The WeChat application is located in a position near the lower edge of the screen, and a display proportion of the WeChat application is 0.2.

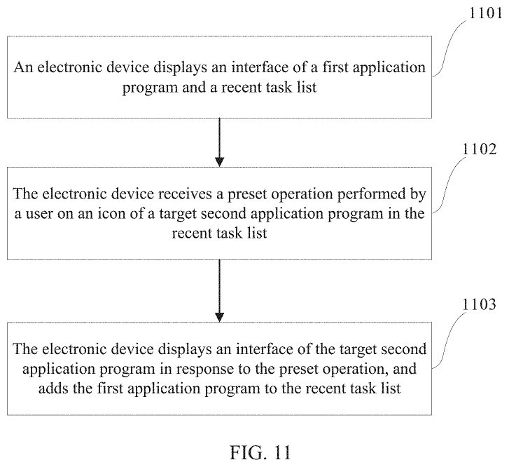

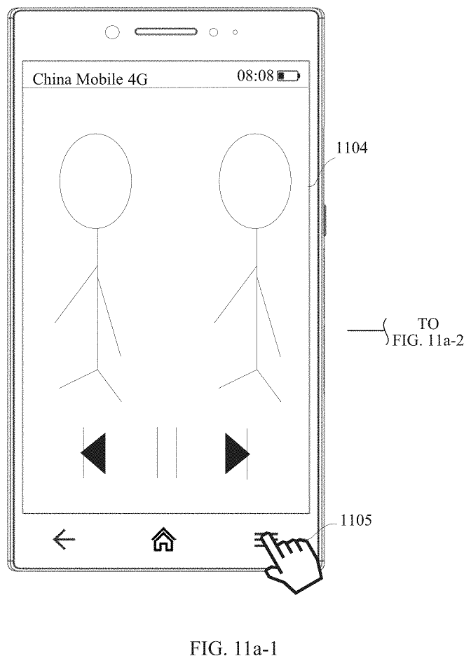

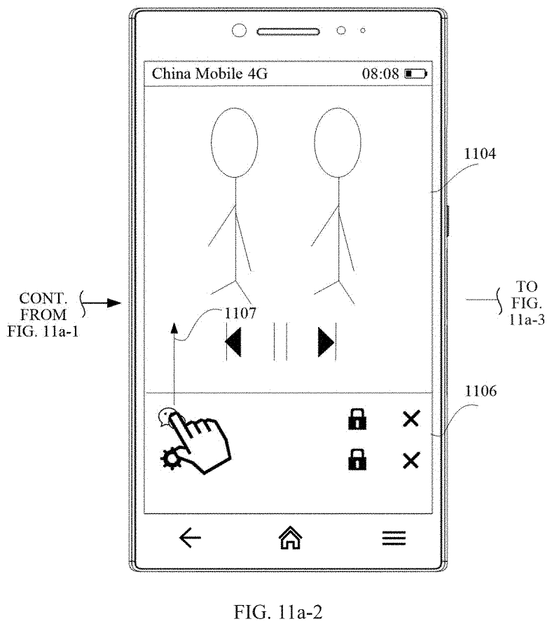

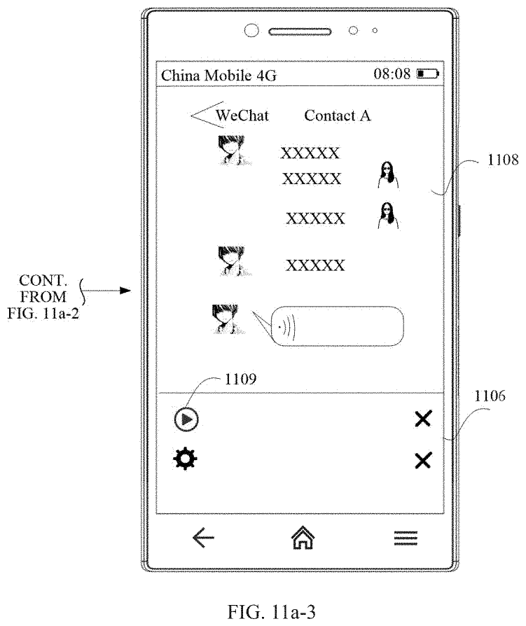

After the electronic device implements fast screen splitting, an embodiment of this application further provides a method that can fast switch an interface of an application program to be displayed currently. Referring to FIG. 11, the method includes the following steps:

1101. An electronic device displays an interface of a first application program and a recent task list.

The recent task list includes an icon of at least one second application program.

In this embodiment of this application, a triggering operation of triggering the electronic device to display the first application program and the recent task list on split screens may be an operation of triggering the electronic device to perform displaying on split screens according to the foregoing method in the embodiment of this application. For example, after a user starts the first application program, the user inputs a specific voice instruction. For another example, when a touch area between a user and a display screen of the electronic device is greater than a threshold, a sliding operation of pulling down from an upper edge of the screen or a sliding operation of pushing up from a lower edge of the screen is triggered. Further, the triggering operation may be a manner of pressing a multi-task function key after the user starts an application, or the like. For a specific implementation, refer to the prior art. Details are not described again herein.

1102. The electronic device receives a preset operation performed by a user on an icon of a target second application program in the recent task list.

The preset operation is used to trigger starting of the target second application program.

Optionally, the preset operation includes an operation of tapping or multi-tapping the icon of the target second application program by the user, an operation of pressing the icon of the target second application program, or an operation of continuously sliding to the interface of the first application program after pressing the icon of the target second application program in the recent task list, where the operation is received by the electronic device from the user.

1103. The electronic device displays an interface of the target second application program in response to the preset operation, and adds the first application program to the recent task list.

In the foregoing method, after the user starts the first application, the first application and the recent task list are triggered, in a manner of pressing a multi-task function key or the like, for displaying on split screens. Further, when the user presses an icon of a second application in the recent task list and continuously slides to the interface of the first application program, display positions of the first application and the second application are interchanged, so that the electronic device displays the interface of the second application, and displays the icon of the first application in the recent task list.

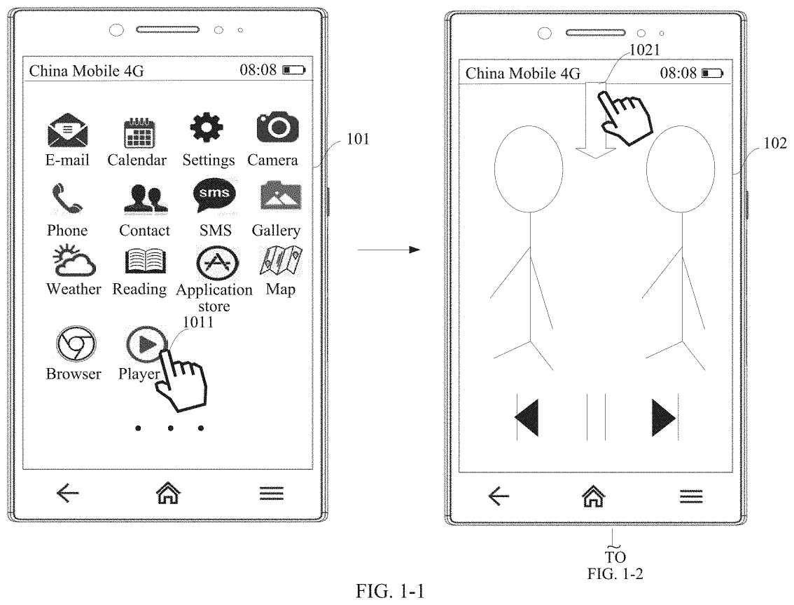

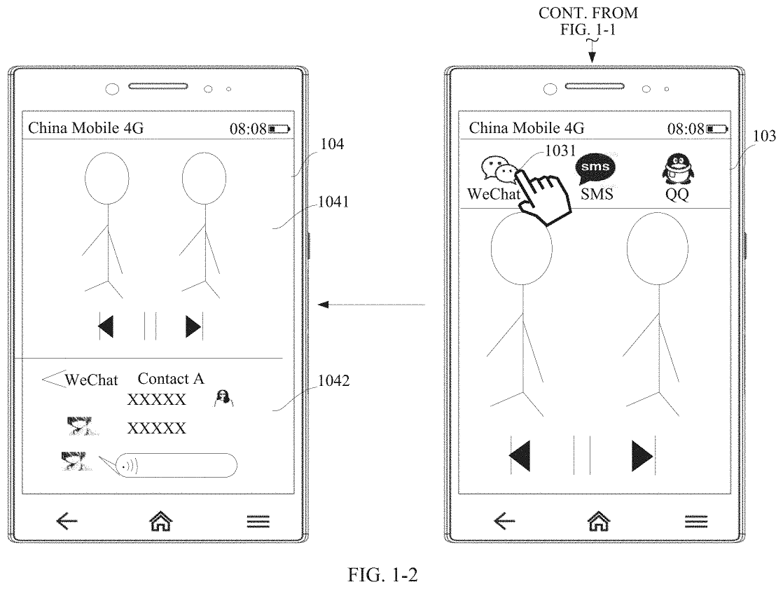

Referring to FIG. 11a-1 to FIG. 11a-3, the electronic device displays an interface 1104 of a video application. As shown by an operation 1105, when the electronic device detects an operation of the user such as pressing the multi-task key, the electronic device displays the interface 1104 of the video application and a recent task list 1106 on split screens. The recent task list 1106 includes icons of application programs recently started by the user, for example, “WeChat” and “settings”. As shown by an operation 1107, when the user presses an icon of the WeChat application and drags the icon to the interface of the video application, the electronic device displays an interface 1108 of the WeChat application and the recent task list 1106 on split screens, where an icon 1109 of the video application is displayed in the recent task list 1106.

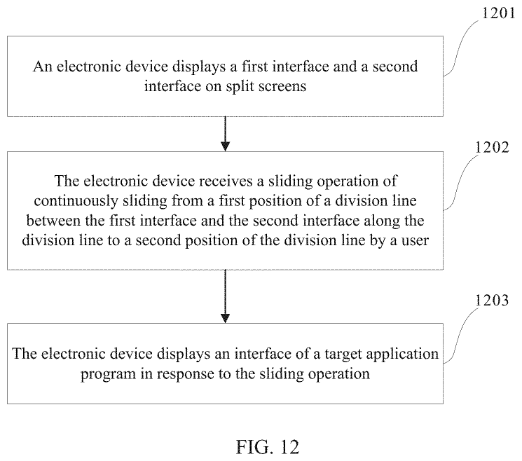

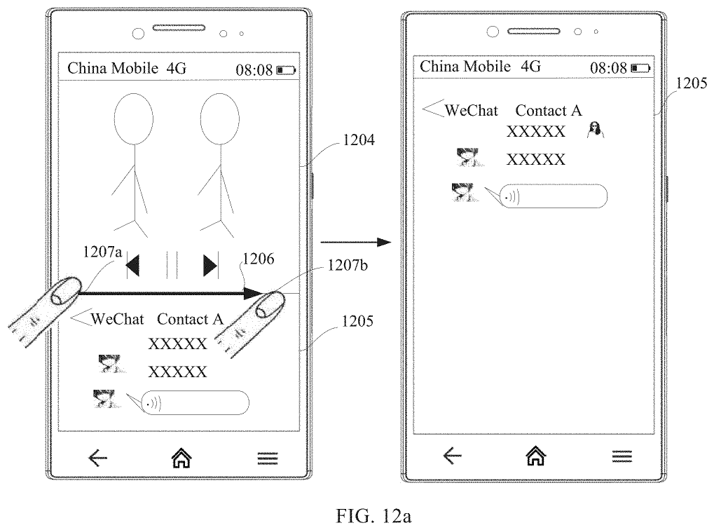

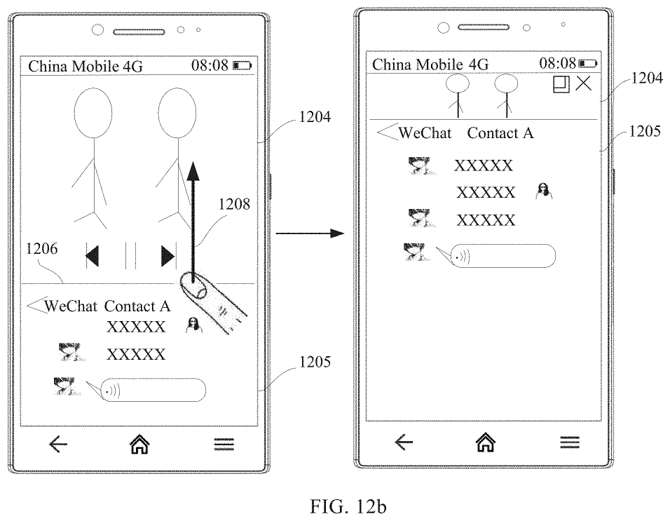

After fast screen splitting of the electronic device is implemented, an embodiment of this application further provides an implementation method for exiting screen splitting. As shown in FIG. 12, the method includes the following steps:

1201. An electronic device displays a first interface and a second interface on split screens.

The first interface is an interface of a first application program, and the second interface is an interface of a second application program.

1202. The electronic device receives a sliding operation of continuously sliding from a first position of a division line between the first interface and the second interface along the division line to a second position of the division line by a user.

The operation shown in step 1202 may be considered as an operation of simulating erasure of the division line by the user.

1203. The electronic device displays an interface of a target application program in response to the sliding operation.

The target application program is one of the first application program and the second application program. Optionally, after the electronic device receives the operation of simulating erasure of the division line by the user as shown in step 1202, the electronic device automatically exits screen splitting, and displays only an application in which a current focus of the user is located. To be specific, the application in which the current focus is located is the target application program. The application in which the current focus of the user is located is an application being operated by the user before the user performs the operation of erasing the division line. For example, if the user is using WeChat for chatting before the user performs the operation of erasing the division line, the WeChat is the application in which the current focus of the user is located. If the user does not perform any operation on any application before the user performs the operation of erasing the division line, the application in which the current focus of the user is located is an application whose display proportion is relatively large.

Referring to FIG. 12a, in an optional implementation, the mobile phone displays an interface 1204 of a video application and an interface 1205 of a WeChat application on split screens. A division line 1206 exists between the interface 1204 of the video application and the interface 1205 of the WeChat application. When the user presses a first position 1207a of the division line 1206 and continuously slides along the division line 1206 to a second position 1207b to simulate the operation of erasing the division line, the mobile phone exits a screen splitting mode, and displays only the interface 1205 of the WeChat application.

Referring to FIG. 12b, in another optional implementation, the mobile phone displays an interface 1204 of a video application and an interface 1205 of a WeChat application on split screens. A division line 1206 exists between the interface 1204 of the video application and the interface 1205 of the WeChat application. As shown by an operation 1208, when the user presses the division line 1206 and then quickly performs an accelerated operation to the interface 1204 of the video application, the mobile phone minimizes the interface 1204 of the video application for displaying, and maximizes the interface 1205 of the WeChat application for displaying. The user may double-tap the interface 1204 of the video application to display the video application and the WeChat application on split screens again. Alternatively (the implementation is not shown in the figure), when the user presses the division line 1206 and then quickly performs an accelerated operation to the interface 1205 of the WeChat application, the mobile phone exits screen splitting, and the mobile phone maximizes the interface 1204 of the video application for displaying, and minimizes the interface 1205 of the WeChat application for displaying.

In another implementation (the implementation is not shown in the figure), when the user presses the division line 1206 and then quickly performs an accelerated operation to the interface 1204 of the video application, the mobile phone exits screen splitting, and displays only the interface 1205 of the WeChat application. Alternatively, when the user presses the division line 1206 and then quickly performs an accelerated operation to the interface 1205 of the WeChat application, the mobile phone exits screen splitting, and displays only the interface 1204 of the video application.

The solutions provided by the embodiments of this application are described above from a perspective of interaction between network elements. It may be understood that, to implement the foregoing functions, the electronic device includes a corresponding hardware structure and/or software module for performing each function. A person skilled in the art should be easily aware that, the units and algorithm steps in the examples described with reference to the embodiments disclosed in this specification can be implemented by hardware or a combination of hardware and computer software in this application. Whether a function is performed by hardware or hardware driven by computer software depends on particular applications and design constraints of the technical solutions. A person skilled in the art may use different methods to implement the described functions for each particular application, but it should not be considered that the implementation goes beyond the scope of this application.

In the embodiments of this application, functional modules in the electronic device may be defined according to the foregoing method examples. For example, each functional module may be defined in a correspondence to each function, or two or more functions may be integrated in one processing module. The integrated module may be implemented in a form of hardware, or may be implemented in a form of a software functional module. It should be noted that, in the embodiments of this application, module division is an example, and is merely logical function division. In an actual implementation, another division manner may be used.

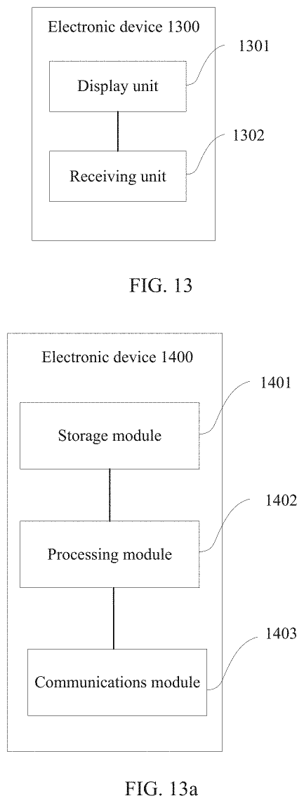

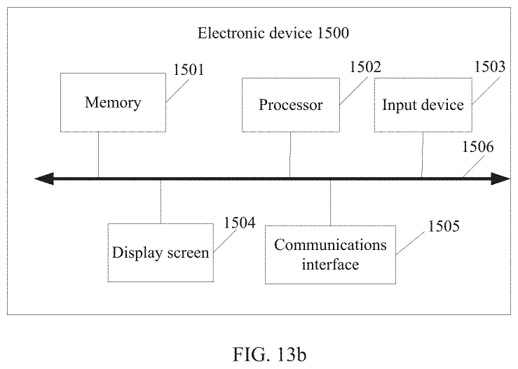

When each functional module is defined in a correspondence to each function, FIG. 13 shows a possible schematic structural diagram of the electronic device in the foregoing embodiment. The electronic device includes a display unit 1301 and a receiving unit 1302. Specifically, the display unit 1301 is configured to support the electronic device in performing a process 401 and a process 403 in FIG. 4, processes 501, 503, and 505 in FIG. 5, processes 601 and 603 in FIG. 6, processes 701 and 703 in FIG. 7, processes 801 and 803 in FIG. 8, processes 901 and 903 in FIG. 9, processes 1101 and 1103 in FIG. 11, and processes 1201 and 1203 in FIG. 12. The receiving unit 1302 is configured to support the electronic device in performing a process 402 in FIG. 4, processes 502 and 504 in FIG. 5, a process 602 in FIG. 6, a process 702 in FIG. 7, a process 802 in FIG. 8, a process 902 in FIG. 9, a process 1102 in FIG. 11, and a process 1202 in FIG. 12.

Optionally, the electronic device may further include a storage unit, where the storage unit is configured to store a historical screen splitting record about displaying the first application program and the second application program on split screens, where the historical screen splitting record includes relative positions of the first application program and the second application program and display proportions of the first application program and the second application program on the display unit of the electronic device.

All related content of steps in the foregoing method embodiments may be cited in function descriptions of corresponding functional modules. Details are not described again herein.

When an integrated unit is used, FIG. 13a shows a possible schematic structural diagram of the electronic device in the foregoing embodiment. The electronic device 1400 includes a processing module 1402 and a communications module 1403. The processing module 1402 is configured to control and manage actions of the electronic device. For example, the processing module 1402 is configured to support the electronic device in performing each process in FIG. 5, FIG. 6, FIG. 7, FIG. 8, FIG. 9, FIG. 11, and FIG. 12, and/or is used in other processes of the technology described in this specification. The communications module 1403 is configured to support communication between the electronic device and another network entity, for example, communication with a base station or another electronic device. The electronic device 1400 may further include a storage module 1401, configured to store program code and data of the electronic device.

The processing module 1402 may be a processor or controller, such as a central processing unit (Central Processing Unit, CPU), a general-purpose processor, a digital signal processor (Digital Signal Processing, DSP), an application-specific integrated circuit (Application-Specific Integrated Circuit, ASIC), a field programmable gate array (Field Programmable Gate Array, FPGA) or another programmable logic device, a transistor logic device, a hardware component, or a combination thereof. The controller or processor may implement or execute various example logical blocks, modules, and circuits described with reference to content disclosed in this application. Alternatively, the processor may be a combination of processors implementing a computing function, for example, a combination of one or more microprocessors, or a combination of the DSP and a microprocessor. The communications module 1403 may be a transceiver, a transceiver circuit, a communications interface, or the like. The storage module 1401 may be a memory.

When the processing module 1402 is a processor, and the communications module 1403 is a communications interface, and the storage module 1401 is a memory, the electronic device in this embodiment of this application may be an electronic device shown in FIG. 13b.

Referring to FIG. 13b, the electronic device 1500 includes a memory 1501, one or more processors 1502, an input device 1503, a display screen 1504, a communications interface 1505, and a bus 1506. The memory 1501, the one or more processors 1502, the input device 1503, the display screen 1504, and the communications interface 1505 are interconnected by using the bus 1506. The bus 1506 may be a peripheral component interconnect (Peripheral Component Interconnect, PCI) bus, an extended industry standard architecture (Extended Industry Standard Architecture, EISA) bus, or the like. The bus may be classified into an address bus, a data bus, a control bus, and the like. For ease of representation, only one thick line is used to represent the bus in FIG. 13b, but this does not mean that there is only one bus or only one type of bus.

Specifically, in an implementation, the display screen 1504 is configured to display icons of a first quantity of application programs; the input device 1503 is configured to receive a preset operation triggered by a user on icons of a second quantity of application programs among the icons of the first quantity of application programs; and the one or more processors 1502 are configured to display, by using the display screen 1504, interfaces of the second quantity of application programs on split screen in an overlapping manner in response to the preset operation.

Specifically, in another implementation, the display screen 1504 is configured to display icons of a first quantity of application programs; the input device 1503 is configured to receive a first operation performed by a user on an icon of a first application program; and the one or more processors 1502 are configured to display, by using the display screen 1504, a first interface and a second interface on split screens in response to the first operation, where the first operation includes any one of the following operations: an operation of tapping the icon of the first application program by using a plurality of fingers, an operation of double-tapping the icon of the first application program, an operation of pressing the icon of the first application program, a first sliding operation of continuously sliding along a first direction after pressing the icon of the first application program, and a second sliding operation of continuously sliding along a second direction to the icon of the first application program after pressing any point other than the icon of the first application program; and the first interface is an interface of the first application program, the second interface is used to display icons of a second quantity of application programs, and the second quantity is less than the first quantity.

Specifically, in still another implementation, the display screen 1504 is configured to display a first interface, where the first interface is an interface of a first application program; the input device 1503 is configured to receive a preset operation performed by a user on the first interface; and the one or more processors 1502 are configured to display, by using the display screen 1504, the first interface and a second interface on split screens in response to the preset operation, where the second interface is used to display an icon of at least one second application program, where the preset operation includes a sliding operation triggered when a touch area between the user and the first interface is greater than a first threshold.

In still another implementation, the display screen 1504 is configured to display a first interface, where the first interface is an interface of a first application program; the input device 1503 is configured to receive a voice instruction input by a user; and the one or more processors 1502 are configured to display, by using the display screen 1504, the first interface and a second interface on split screens in response to the voice instruction.

In still another implementation, the display screen 1504 is configured to display a first interface, where the first interface displays an icon of at least one application program; the input device 1503 is configured to receive a preset operation performed by a user on an icon of a first application program in the at least one application program; and the one or more processors 1502 are configured to display, by using the display screen 1504, an interface of the first application program on the first interface in an overlapping manner in response to the preset operation, where the preset operation includes an operation of continuously sliding along a first direction after pressing the icon of the first application program.

In still another implementation, the display screen 1504 is configured to display an interface of a first application program and a recent task list, where the recent task list includes an icon of at least one second application program; the input device 1503 is configured to receive a preset operation performed by a user on an icon of a target second application program in the recent task list, where the preset operation is used to trigger starting of the target second application program; and the one or more processors 1502 are configured to display, by using the display screen 1504, an interface of the target second application program in response to the preset operation, and add the first application program to the recent task list.

In still another implementation, the display screen 1504 is configured to display a first interface and a second interface on split screens, where the first interface is an interface of a first application program, and the second interface is an interface of a second application program; the input device 1503 is configured to receive a sliding operation of continuously sliding from a first position of a division line between the first interface and the second interface along the division line to a second position of the division line by a user; and the one or more processors 1502 are configured to display, by using the display screen 1504, an interface of a target application program in response to the sliding operation, where the target application program is one of the first application program and the second application program.

Method or algorithm steps described with reference to the content disclosed in this application may be implemented by hardware, or may be implemented by a processor by executing a software instruction. The software instruction may include a corresponding software module. The software module may be stored in a random access memory (Random Access Memory, RAM), a flash memory, a read only memory (Read Only Memory, ROM), an erasable programmable read only memory (Erasable Programmable ROM, EPROM), an electrically erasable programmable read only memory (Electrically EPROM, EEPROM), a register, a hard disk, a mobile hard disk, a compact disc read-only memory (CD-ROM), or any other form of storage medium well-known in the art. For example, a storage medium is coupled to a processor, so that the processor can read information from the storage medium or write information into the storage medium. Certainly, the storage medium may be a component of the processor. The processor and the storage medium may be located in the ASIC.

A person skilled in the art should be aware that in the foregoing one or more examples, functions described in this application may be implemented by hardware, software, firmware, or any combination thereof. When the present invention is implemented by software, the foregoing functions may be stored in a computer-readable medium or transmitted as one or more instructions or code in the computer-readable medium. The computer-readable medium includes a computer storage medium and a communications medium, where the communications medium includes any medium that enables a computer program to be transmitted from one place to another. The storage medium may be any available medium accessible to a general-purpose or dedicated computer.

The objectives, technical solutions, and benefits of this application are further described in detail in the foregoing specific embodiments. It should be understood that the foregoing descriptions are merely specific embodiments of this application, but are not intended to limit the protection scope of this application. Any modification, equivalent replacement or improvement made based on the technical solutions of this application shall fall within the protection scope of this application.

1-37. (canceled)

38. An electronic device comprising:
a display screen;
a memory configured to store instructions; and
a processor coupled to the memory and configured to execute the instructions to cause the electronic device to:
display a no-division screen;
lock the display screen;
unlock the display screen; and
simultaneously display a first area, a second area, and a division line separating the first area and the second area on the display screen, wherein the first area comprises a first launched application program within the first area, and wherein the second area comprises either a second launched application program or a plurality of application program icons within the second area.

39. The electronic device of claim 38, wherein the processor is further configured to unlock the display screen and simultaneously display the first area and the second area based on receiving a user input.

40. The electronic device of claim 39, wherein the user input comprises user biological information.

41. The electronic device of claim 39, wherein the user input comprises a preset shortcut operation.

42. The electronic device of claim 39, wherein the user input comprises a voice input.

43. The electronic device of claim 38, wherein the memory is further configured to store a plurality of preset shortcut operations, and wherein the processor is further configured to select the first launched application program based on which one of the preset shortcut operations is inputted into the electronic device.

44. The electronic device of claim 38, wherein the processor is further configured to select the first launched application program based on a historical user screen splitting habit.

45. An electronic device comprising:
a display screen;
a memory configured to store instructions; and
a processor coupled to the memory and configured to execute the instructions to cause the electronic device to:
receive a first user input;
simultaneously display a first area and a second area on the display screen in response to the first user input, wherein the first area comprises a first launched application program within the first area, and wherein the second area comprises an application program icon;
receive a second user input; and
display a second launched application program within the second area in response to the second user input, wherein the second launched application program corresponds to the application program icon.

46. The electronic device of claim 45, wherein the first area and the second area are displayed in a picture-in-picture mode, and wherein the first area overlaps the second area.

47. The electronic device of claim 45, wherein the first area and the second area are displayed in a split-screen mode, and wherein the processor is further configured to display on the display screen a division line separating the first area and the second area.

48. The electronic device of claim 47, wherein the processor is further configured to:
receive a third user input; and
move a location of the division line in response to the third user input.

49. The electronic device of claim 47, wherein the processor is further configured to:
receive a third user input; and
switch locations of the first launched application program and the second launched application program in response to the third user input such that the first launched application program is displayed in the second area and the second launched application program is displayed in the first area.

50. The electronic device of claim 45, wherein the display screen is configured to:
be in a locked state before receiving the first user input; and
unlock in response to the first user input.

51. The electronic device of claim 45, wherein the display screen is configured to be in an unlocked state before receiving the first user input.

52. A method, implemented by an electronic device, comprising:
receiving a user input; and
simultaneously displaying a first area and a second area on a display screen of the electronic device in response to the user input, wherein the first area comprises a first launched application program within the first area, and wherein the second area comprises either a second launched application program or a plurality of application program icons within the second area.

53. The method of claim 52, wherein the user input comprises one of a plurality of user fingerprints, and wherein the method further comprises selecting the first launched application program in response to the user input.

54. The method of claim 52, wherein the user input comprises one of a plurality of preset shortcut operations, and wherein the method further comprises selecting the first launched application program in response to the user input.

55. The method of claim 52, wherein the user input is received when the display screen is in a locked state.

56. The method of claim 52, wherein the user input is received when the display screen is in an unlocked state.

57. The method of claim 52, wherein a first size of the first area and a second size of the second area are based on a historical user screen splitting habit.
